(19) United States
(12) Patent Application Publication
(10) Pub. No.: US 2025/0304343 A1
(43) Pub. Date: Oct. 2, 2025

(54) PACKAGING MATERIAL AND PACKAGES WITH SLIT FLUTES AND METHOD OF MANUFACTURING THE SAME

(71) Applicant: PAC WORLDWIDE CORPORATION, Redmond, WA (US)

(72) Inventors: Paul Andrew FREDERICK, Harrison, OH (US); Paul Matthew NEAL, Fairfield, OH (US); Brian Andrew KENDALL, Maineville, OH (US); Martha Ines Victoria RIVEROS, Bay Village, OH (US)

(21) Appl. No.: 18/863,526

(22) PCT Filed: May 9, 2023
(86) PCT No.: PCT/US2023/021572

§ 371 Date: Nov. 6, 2024

Related U.S. Application Data
(60) Provisional application No. 63/340,385, filed on May 10, 2022.
(60) Provisional application No. 63/357,583, filed on Jun. 30, 2022.

(51) Int. Cl. B65D 65/40; B31B 70/26; B31B 70/64; B31B 170/20; B31B 170/30; B65D 65/46; B65D 81/03

(52) U.S. Cl. CPC B65D 65/403; B31B 70/262; B31B 70/644; B65D 65/466; B65D 81/03; B31B 2170/20; B31B 2170/30; B65D 2565/385

(57) ABSTRACT

The present disclosure is directed to embodiments of packages as well as embodiments of packaging materials for forming the embodiments of the packages. In at least one embodiment of a package, the package includes a plurality of slits or cuts that extends through an inner fluted layer that is adhered to an outer external layer of the package. The inner fluted layer is present within an internal cavity of the package in which variously sized and shaped products may be placed to ship these respective products to customers. The plurality of slits provide conformability, flexibility, and bendability such that the package may more readily conform to these respective products. The plurality of slits may define sub-flutes of the fluted layer that are configured to protect and provide cushion to reduce the likelihood of the respective products within the packages being damaged while underway to their destination.

### BACKGROUND

### Technical Field

The present disclosure is directed to packaging materials and packages that include the packaging materials as well as methods of forming and manufacturing the same.

### Description of the Related Art

Retailers (e.g., online retailers, brick-and-mortar retailers, specialty retailers, etc.) ship thousands of products that are sold to buyers and consumers on a regular basis either in-person, over the phone, or through a website. These products (e.g., an object, an item, an electronic device, a candle, an article of clothing, a beverage can, a beverage container, etc.) come in any number of different shapes or sizes. Some of these products, such as candles, may come in outer containers such as a jar, which may be made of glass. These products may be placed within conventional shipping containers or packages that protect the products to reduce a likelihood of the products breaking or being damaged while being shipped to a customer.

These products that are to be shipped in these conventional shipping containers or packages have various sizes and shapes and the conventional shipping containers or packages may include conventional bubbles or liners within the packages that are structured to protect and reduce the likelihood of the products being damaged when being shipped to the customer. For example, a conventional bubble mailer may include a plurality of bubbles to protect the product within the bubble mailer when dropped or jostled during shipment. Generally, these conventional bubble mailers can be recycled if the components or materials (e.g., separate layers) are manually separated and delivered to a recycling facility that recycles the components or materials of these conventional bubble mailers. However, most customers, consumers, or buyers are unaware that these components or materials should be separated to be properly recycled or do not have the capacity to breakdown the conventional bubble mailers. This results in many conventional bubble mailers used today ending up in landfills harming the environment and the planet.

These products that have various sizes and shapes may result in a retailer having multiple different sized and shaped conventional shipping containers or packages to mail the various sized and shaped products. For example, a retailer may purchase and utilize first conventional shipping packages having a first volume and shape as well as purchase and utilize second conventional shipping packages with a second volume and shape that is larger and different from the first conventional shipping packages. For example, the first conventional shipping packages may be utilized to ship smaller products whereas the second conventional shipping packages may be utilized to ship larger products.

### BRIEF SUMMARY

The present disclosure is directed to at least one embodiment of a package including a first end, a second end opposite to the first end, a first side that extends from the first end to the second end, and a second side opposite to the first side that extends from the first end to the second end. The at least one embodiment of the package further includes an outer layer made of a first recyclable material and an inner layer made of a second recyclable material, which may be the same as the first recyclable material. The outer layer including an internal surface and an external surface opposite to the internal surface. The inner layer is coupled to the outer layer, for example, by an adhesive. The inner layer including a plurality of sub-flutes having peaks spaced apart from the outer layer and valleys coupled to the internal surface of the outer layer. Each one of the peaks is between adjacent ones of the valleys and each one of the valleys is between adjacent ones of the peaks. A plurality of slits extends through the plurality of sub-flutes and define each respective sub-flute of the plurality of sub-flutes. A first sealed edge of the package is at the first side of the package. A second sealed edge of the package is at the second side of the package, which is opposite to the first side of the package. A folded edge of the package is at the second end of the package and extends from the first sealed edge to the second sealed edge. An opening of the package is at the first end of the package. A product may be placed within an internal cavity of the at least one embodiment of the package through the opening. After the product is within the internal cavity, a flap of the package at the first end may be folded over and adhered to the external surface of the outer layer to enclose the product within the internal cavity of the package by closing off the opening.

The present disclosure is directed to at least one embodiment of a packaging material including an outer layer made of a first recyclable material and an inner layer made of a second recyclable. The outer layer including an internal surface and an external surface opposite to the internal surface. The inner layer is coupled to the internal surface of the outer layer. The inner layer including a plurality of sub-flutes having peaks spaced apart from the outer layer and valleys coupled to the internal surface of the outer layer. Each one of the peaks is between adjacent ones of the valleys and each one of the valleys is between adjacent ones of the peaks. The package further includes a plurality of slits that extends past and along the plurality of sub-flutes and define each respective sub-flute of the plurality of sub-flutes.

The present disclosure is directed to at least one embodiment of a package including a first end, a second end opposite to the first end, a first side extends from the first end to the second end, and a second side opposite to the first side extends from the first end to the second end. The package further includes an outer layer made of a first recyclable material and an inner layer made of a second recyclable material, which may be the same as the first recyclable material. The outer layer including an internal surface and an external surface opposite to the internal surface, and the inner layer is coupled to the outer layer. The inner layer including a plurality of flutes having peaks spaced apart from the outer layer and valleys coupled to the internal surface of the outer layer. Respective ones of the peaks are between adjacent ones of the valleys and respective ones of the valleys are between adjacent ones of the peaks. The inner layer further includes a plurality of patterned slits that extends through the plurality of flutes. A first sealed edge of the package is at the first side of the package. A second sealed edge of the package is at the second side of the package. A folded edge of the package is at the second end of the package. An opening of the package is at the first end of the package.

The present disclosure is directed to at least one embodiment of a packaging material including a fluted layer made of a first recyclable material, a shell layer made of a second recyclable material, which may be the same as the first recyclable material, and a patterned slit extending through the fluted layer.

The present disclosure is directed to at least one embodiment of a packaging material, including a first layer made of a first recyclable material. The first layer including a first surface and a second surface opposite to the first surface. A second layer made of a second recyclable material is coupled to the first layer. The second recyclable material may be the same as the first recyclable material. The second layer includes a pair of sub-fluted regions having a plurality of sub-flutes with peaks spaced apart from the outer layer and valleys coupled to the internal surface of the outer layer. Each one of the peaks is between adjacent ones of the valleys and each one of the valleys is between adjacent ones of the peaks. A plurality of slits extends past and along the plurality of sub-flutes and define each respective sub-flute of the plurality of sub-flutes. A fluted region of the second layer is between a first one and a second one of the pair of sub-fluted regions of the second layer. The fluted region including a plurality of flutes that extends from the first one to the second one of the pair of sub-fluted regions.

These various embodiments of the packages and packaging materials of the present disclosure or within the scope of present disclosure provide conformability, flexibility, and bendability such that the embodiments of the packages may more readily conform to the variously sized and shaped products. For example, the plurality of slits or patterned slits extending through flutes of the inner layers of the packages are configured to provide conformability while also providing protection and cushioning to reduce the likelihood of the respective product within the package being damaged while underway to its destination.

### BRIEF DESCRIPTION OF THE SEVERAL VIEWS OF THE DRAWINGS

For a better understanding of the embodiments, reference will now be made by way of example to the accompanying drawings. In the drawings, identical reference numbers identify similar elements or acts unless the context indicates otherwise. The sizes and relative proportions of the elements in the drawings are not necessarily drawn to scale. For example, some of these elements may be enlarged and positioned to improve drawing legibility.

FIG. 1A is an end view of an embodiment of a package of the present disclosure;

FIG. 1B is a perspective view of the embodiment of the package as shown in FIG. 1A;

FIG. 1C is a top plan view of an inner layer of the embodiment of the package as shown in FIGS. 1A and 1B;

FIG. 1D is a zoomed in view of the inner layer of the embodiment of the package as shown in FIGS. 1A-1C;

FIG. 2A is a perspective view of an embodiment of a packaging material of the present disclosure;

FIG. 2B is a perspective view of the embodiment of the packaging material as shown in FIG. 2A;

FIG. 2C is a zoomed in, perspective view of the embodiment of the packaging material as shown in FIGS. 2A and 2B;

FIG. 2D is a zoomed in, perspective view of the embodiment of the packaging material as shown in FIGS. 2A-2C;

FIG. 3 is a perspective view of the embodiment of the packaging material as shown in FIGS. 2A-2D being bent;

FIG. 4 is a perspective view of an embodiment of a cutting end of a router to manufacture the embodiment of the packaging material as shown in FIGS. 2A-2D;

FIG. 5 is a perspective view of an embodiment of a method of manufacturing the packaging material as shown in FIGS. 2A-2D with the embodiment of the cutting end of the router as shown in FIG. 4;

FIG. 6 is a perspective view of an embodiment of a cutting end of a cutting device to manufacture the embodiment of the packaging material as shown in FIGS. 2A-2D;

FIG. 7 is a perspective view of an embodiment of a cutting end of a cutting device to manufacture the embodiment of the packaging material as shown in FIGS. 2A-2D;

FIG. 8A is a perspective view of an alternative embodiment of a packaging material of the present disclosure;

FIG. 8B is a perspective view of the alternative embodiment of the packaging material as shown in FIG. 8A;

FIG. 9 is a perspective view of a method of manufacturing an alternative embodiment of the packaging material as shown in FIGS. 8A and 8B as well as other alternative embodiments of packaging materials of the present disclosure;

FIG. 10 is a perspective view of an alternative embodiment of a packaging material of the present disclosure passing through a package formation machine;

FIG. 11 is a top plan view of an alternative embodiment of a packaging material of the present disclosure;

FIG. 12 is a top plan view of an alternative embodiment of a packaging material of the present disclosure;

FIG. 13 is a top plan view of an alternative embodiment of a packaging material of the present disclosure;

FIG. 14A is a top plan view of an alternative embodiment of a packaging material of the present disclosure;

FIG. 14B is a perspective view of the alternative embodiment of the packaging material as shown in FIG. 14A of the present disclosure;

FIG. 14C is a cross-sectional view of the alternative embodiment of the packaging material taken along line 14C-14C as shown in FIG. 14A;

FIG. 14D is a front side view of one sub-flute of the alternative embodiment of the packaging material as shown in FIGS. 14A-14C;

FIG. 15A is a top plan view of an alternative embodiment of a packaging material of the present disclosure;

FIG. 15B is a cross-sectional side view of the alternative embodiment of the packaging material taken along line 15B-15B as shown in FIG. 15A of the present disclosure;

FIG. 16A is a top plan view of an alternative embodiment of a packaging material of the present disclosure;

FIG. 16B is a perspective view of the alternative embodiment of the packaging material as shown in FIG. 16A;

FIG. 16C is a side view of the alternative embodiment of the packaging material as shown in FIGS. 16A and 16B; and

FIG. 16D is a front side view one sub-flute of the alternative embodiment of the packaging material as shown in FIGS. 16A-16C.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures and components associated with shipping containers or forming shipping containers have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second, third, fourth, etc., does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “top,” “bottom,” “upper,” “lower,” “vertical,” “horizontal,” “left,” and “right,” are used herein to refer to orientations of components as they are illustrated in the Figures.

As used in this specification and the appended claims, the singular forms “a,” “an,” and “the” include plural referents unless the context clearly dictates otherwise.

The various embodiments of packages of the present disclosure or within the scope of present disclosure as well as embodiments of packaging materials for forming these embodiments of the packages provide conformability, flexibility, and bendability while providing cushioning. For example, the embodiments of the packages of the present disclosure may more readily conform to the variously sized and shaped products while cushioning and protecting the products during shipment. For example, a plurality of slits or patterned slits extends through flutes of the inner layers of the packages and are configured to provide conformability while also providing protection and cushioning to reduce the likelihood of the respective product within the package being damaged while underway to its destination. In other words, the plurality of slits define sub-flutes, and the sub-flutes are configured to function similar to bubbles of a bubble mailer.

The various embodiments of the packages and packaging materials or within the scope of the present disclosure may be made of recyclable and/or biodegradable materials such that the various embodiments of the packages and the packaging materials are recyclable and/or biodegradable without having to be broken apart or down into various sub-components or layers beforehand. For example, unlike a package made of multiple different types of recyclable materials (e.g., both paper and plastic) that has to be broken down into the different materials before being recycled, the packages of the present disclosure may be recycled as an entire unit. For example, the recyclable materials of the packages and packaging materials of the present disclosure may be made of a plant-based or fiber-based material that is recyclable, biodegradable, or both.

The various embodiments of the packages of the present disclosure or within the scope of the present disclosure may be formed utilizing the various embodiments of the packaging materials of the present disclosure or within the scope of the present disclosure.

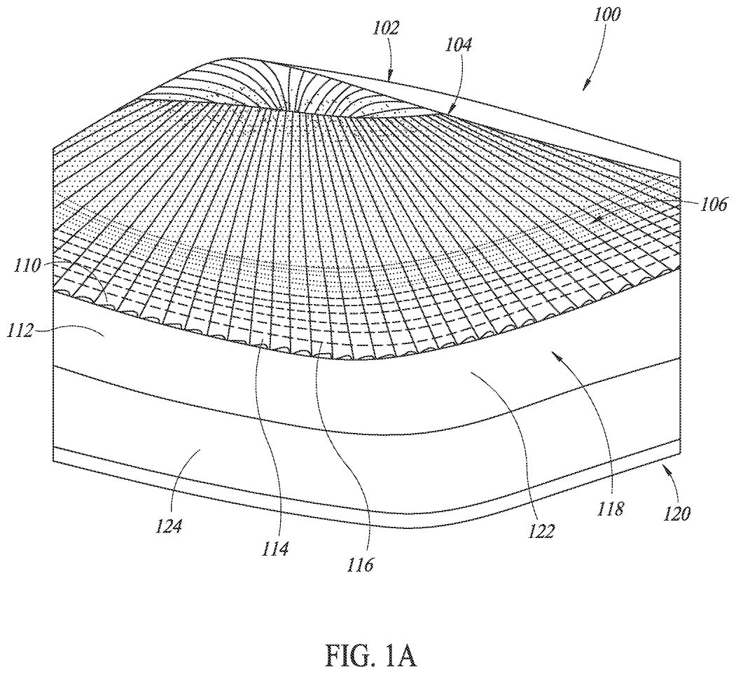

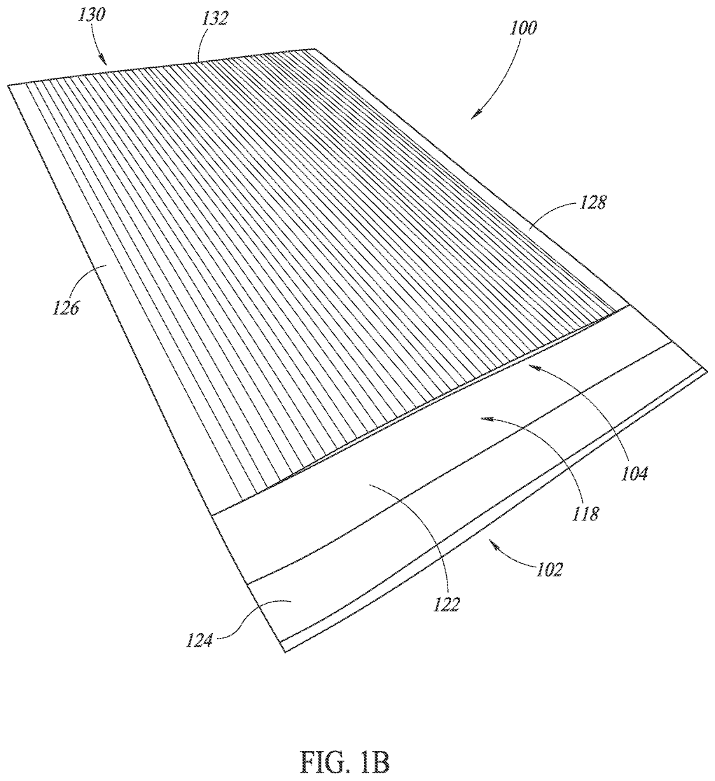

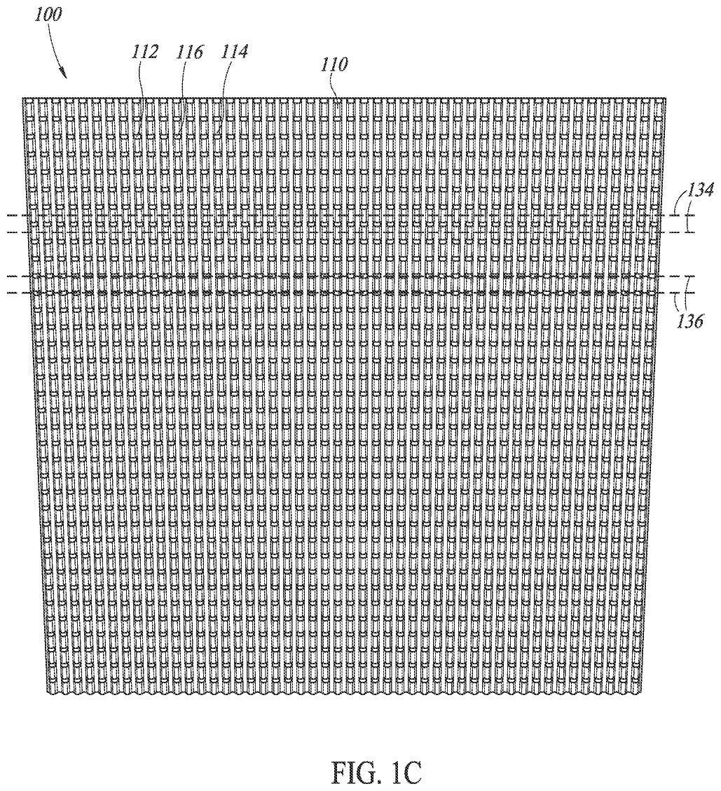

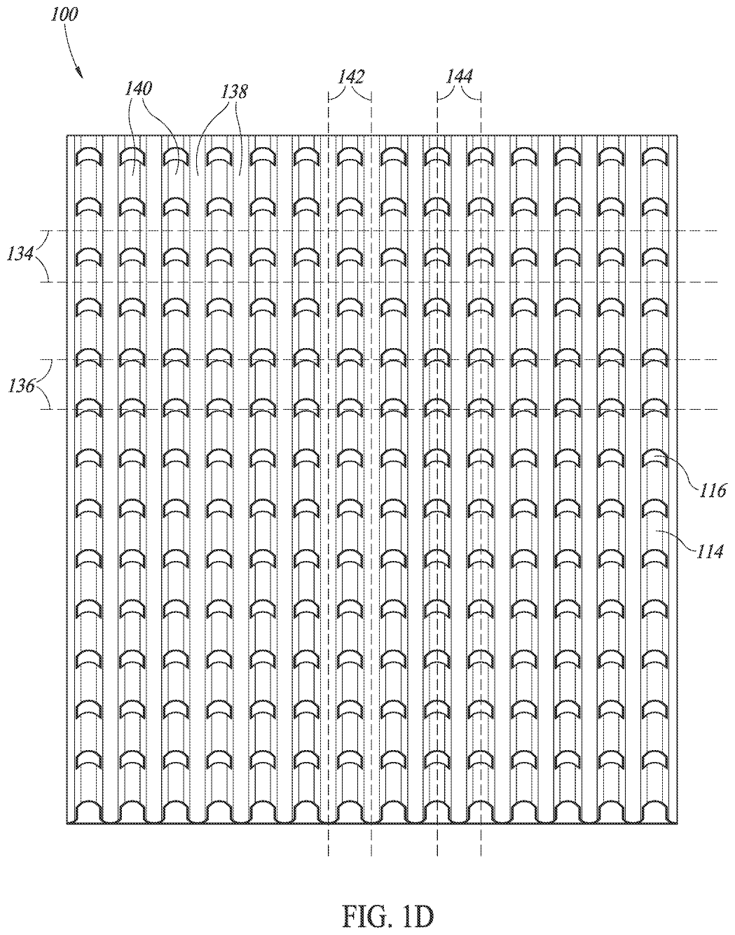

FIG. 1A is an end view of a package 100, which includes a first end 102 at which an opening 104 is present and provides access to an internal cavity 106 within the package 100. For example, a product may be placed within the package 100 into the internal cavity 106 by passing the product through the opening 104 into the internal cavity 106. The package 100 may be referred to as a package mailer, an envelope, or some other type of reference to the package 100 being configured to ship a product to a customer.

An inner, interior, or internal layer 110 of the package 100 is coupled to an outer, exterior, or external layer 112. The inner layer 110 may be a corrugated layer such as a corrugated layer of a cardboard structure. The outer layer 112 is made of a first recyclable and/or biodegradable material, and the inner layer is made of a second recyclable and/or biodegradable material. The outer layer 112 may be a base layer of a corrugated cardboard structure. For example, the inner layer 110 and the outer layer 112 may be similar in structure to a single face cardboard corrugated structure.

The first and second recyclable and/or biodegradable materials may be a plant-based material, a fiber-based material, or a pulp-based material (e.g., cotton, flax, wood, hemp, etc.). In some embodiments, the first and second recyclable and/or biodegradable materials may be the same type of recyclable and/or biodegradable material, and, in some alternative embodiments, the first and second recyclable and/or biodegradable materials may be different types of recyclable and/or biodegradable materials. However, the first and second recyclable and/or biodegradable materials may be selected such that the package 100 is recyclable or compostable as a complete unit. For example, the package 100 may be placed directly into a recycling container or receptacle to recycle the package 100 or within a compost container or receptacle for composting the package 100 without having to breakdown the package 100 beforehand. This recyclability and/or compostability of the package 100 allows for the package 100 to be properly recycled and/or composted such that a consumer does not have to have specific knowledge to be aware of how to properly recycle and/or compost the package 100. The inner layer 110 may be one of a pair of opposing inner layers such that the internal cavity 106 is fully lined with the opposing inner layers as shown in FIG. 1A. The outer layer 112 may be one of a pair of opposing outer layers to which the opposing inner layers are coupled as shown in FIG. 1A. The inner and outer layers 110, 112 of the package 100 may previously have been portions of one or more of respective packaging materials 200, 500, 600, 700, 800, 900, 1000, 1100, 1200 as discussed later herein.

The inner layer 110 includes a plurality of slits 116 and a plurality of sub-flutes 114 that are defined by the plurality of slits 116. For example, each respective sub-flute of the plurality of sub-flutes 114 are spaced apart from at least one adjacent one of the plurality of sub-flutes 114 by at least one of the respective slits of the plurality of slits 116. The plurality of sub-flutes 114 are configured to provide conformability of the package 100 such that the package 100 more readily conforms to variously sized and shaped products that are shipped to consumers within the package 100. The plurality of sub-flutes 114 are configured to provide cushion and support to the variously sized and shaped products that are shipped to consumers within the package 100 to reduce the likelihood of the variously sized and shaped products being damaged when underway to the consumer. For example, the plurality of sub-flutes 114 may provide cushion or support similar to bubbles of a bubble mailer. However, unlike conventional bubble mailers that generally have to be broken down into various components before being placed within a recycling container or receptacle, the package 100 may be recycled and/or composted as a complete unit. In other words, unlike the conventional bubble mailers that are made of plastic that have to be broken down into separate components (e.g., separate layers), the package 100 is recyclable and/or compostable regardless of whether the package 100 is broken down into separate components (e.g., separate layers) or is not broken down into separate components (e.g., separate layers).

The inner layer 110 is coupled to an internal surface 118 of the outer layer 112, and an external surface 120 of the outer layer 112 is opposite to the internal surface 118 of the outer layer 112. The external surface 120 is at an exterior of the package such that the external surface 120 is exposed to an environment outside the internal cavity 106 of the package 100. The inner layer 110 may be coupled to the internal surface 118 of the outer layer 112 by an adhesive such as a glue. The adhesive may be a thermally activated adhesive, a pressure activated adhesive, a thermal and pressure activated adhesive, or some other type of adhesive that is suitable for adhering the inner layer 110 to the outer layer 112. The adhesive may be selected and utilized such that the package 100 remains recyclable and/or compostable as a complete unit even when the package 100 is not broken down before being placed within a recycling receptacle or container or within a composting receptacle or container.

The package 100 further includes a closure flap 122 at the first end 102 of the package 100. A release liner 124 is present on the closure flap 122 and covers an adhesive layer on the closure flap 122. The closure flap 122 may be utilized to close the package 100 by removing the release liner 124 from the closure flap 122 exposing the adhesive previously covered by the release liner 124, folding over the closure flap 122, and adhering an inner surface of the closure flap 122, which is part of the internal surface 118, to the exterior of the package 100. In some alternative embodiments of the package 100, the closure flap 122 may not be present and instead the opening 104 may be sealed off in some other manner. For example, the opening may be sealed off by an adhesive layer that extends across the opening 104.

The plurality of sub-flutes 114 of the package 100 may include a first set of sub-flutes and a second set of sub-flutes on opposite sides of the internal cavity 106 that face each other and are offset relative to each other. For example, the first set of sub-flutes are on a lower internal surface of the outer layer 112 and the second set of sub-flutes are on an upper internal surface of the outer layer 112 based on the orientation as shown in FIG. 1A. The lower and upper internal surfaces of the outer layer 112 face inwards towards the internal cavity. The lower and upper internal surfaces of the outer layer 112 may be the same or similar to the internal surface 118. The offset positioning of the first set of sub-flutes relative to the second set of sub-flutes results in the respective peaks of the second set of sub-flutes nesting within respective valleys of the first set of sub-flutes and respective peaks of the first set of sub-flutes nesting within respective valleys of the second set of sub-flutes when the package 100 is laid flat.

FIG. 1B is a perspective view of one side of the exterior of the package 100 as shown in FIG. 1A. The reverse side of the package 100 opposite to the side as shown in FIG. 1B may be similar to the side of the package as shown in FIG. 1B. The package 100 includes a first sealed edge 126 at a left-hand side of the package 100 based on the orientation as shown in FIG. 1B, and a second sealed edge 128 at a right-hand side of the package 100 based on the orientation as shown in FIG. 1B. The first and second sealed edges 126, 128 may be referred to as a pair of opposing sealed edges that are opposite to each other.

A second end 130 of the package 100 is opposite to the first end 102 of the package 100. A folded edge 132 is at the second end 130 of the package 100. In some alternative embodiments, the folded edge 132 may be instead be a third sealed edge similar to the first and seconds sealed edges 126, 128, respectively.

The first and second sealed edges 126, 128 extend from the second end 130 to the first end 102. The folded edge 132 is transverse to the first and second sealed edges 126, 128 and extends from the first sealed edge 126 to the second sealed edge 128. At the folded edge 132, the inner layer 110 and the outer layer 112 may be folded about the folded edge 132 such that the internal cavity 106 is defined by the first sealed edge 126, the second sealed edge 128, and the folded edge 132 at least along three sides. When the package 100 is closed by folding over the closure flap 122 and sealing the package 100 utilizing the adhesive previously covered by the release liner 126, a folded edge is present at the first end 102 of the package 100. The folded edge at the first end 102 of the package 100 is opposite to the folded edge 132 at the second end 130 of the package 100. In some embodiments of the package 100, the package 100 may include a tear away strip such that the package 100 may be opened utilizing the tear away strip and then reutilized to ship a product back to the retailer, for example, when a consumer is returning the product to the seller.

The plurality of sub-flutes 114 and the plurality of slits 116 may be present along the entirety of the inner layer 110, which extends from the opening 104 to the folded edge 132. For example, while only some of the plurality of sub-flutes 114 and the plurality of slits 116 are shown in FIG. 1A for simplicity sake, in some embodiments, the plurality of sub-flutes 114 and the plurality of slits 116 are present along the entirety of the inner layer 110 that lines the internal cavity of the package 100 (e.g., see FIG. 1C).

FIG. 1C is a top plan view of the inner layer 110 on the outer layer 112 of the package 100 as shown in FIGS. 1A and 1B. As shown in FIG. 1C, the plurality of slits 116 separate and define each one of the plurality of sub-flutes 114.

FIG. 1D is a zoomed-in view of the inner layer 110 on the outer layer 112 of the package 100 as shown in FIGS. 1A and 1B. A plurality of first lines 134 along ones of the plurality of sub-flutes 114 extends across the package 100 in a direction directed from the first sealed edge 126 to the second sealed edge 128. As shown in FIG. 1D, the plurality of first lines 134 are substantially parallel with the folded edge 132 and substantially orthogonal or perpendicular to the first and second sealed edges 126, 128, respectively. In some alternative embodiments, the plurality of first lines 134 may instead be substantially perpendicular or orthogonal with the folded edge 132 and substantially parallel to the first and second sealed edges 126, 128, respectively. In some alternative embodiments, the plurality of first lines 134 along which ones of the plurality of sub-flutes 114 are present may be transverse to both the folded edge 132 and the first and second sealed edges 126, 128, respectively. For example, instead of the plurality of first lines 134 being horizontally-oriented based on the orientation of the package 100 as shown in FIG. 1D, in the alternative embodiments, the plurality of first lines 134 may be diagonally-oriented based on the orientation of the package 100 as shown in FIG. 1D.

A plurality of second lines 136 along which ones of the plurality of slits 116 are present extends across the package 100 in the direction directed from the first sealed edge 126 to the second sealed edge 128. As shown in FIG. 1D, the plurality of second lines 136 are substantially parallel with the folded edge 132 and substantially orthogonal or perpendicular to the first and second sealed edges 126, 128, respectively. In some alternative embodiments, the plurality of second lines 136 may instead be substantially perpendicular or orthogonal with the folded edge 132 and substantially parallel to the first and second sealed edges 126, 128, respectively. In some alternative embodiments, the plurality of second lines 136 along which ones of the plurality of slits 116 are present may be transverse to both the folded edge 132 and the first and second edges 126, 128, respectively. For example, instead of the plurality of second lines 136 being horizontally oriented based on the orientation of the package 100 as shown in FIG. 1D, in the alternative embodiments, the plurality of second lines 136 may be diagonally oriented based on the orientation of the package 100 as shown in FIG. 1D.

The plurality of sub-flutes 114 include a plurality of valleys 138 and a plurality of peaks 140. The plurality of valleys 138 are along a plurality of third lines 142 and the plurality of peaks 140 are along a plurality of fourth lines 144. The pluralities of third and fourth lines 142, 144 are orthogonal or perpendicular to the pluralities of first and second lines 134, 136. In some alternative embodiments, the pluralities of third and fourth lines 142, 144 are not orthogonal or perpendicular to the pluralities of first and second lines 134, 136, but, instead, the pluralities of the third and fourth lines 142, 144 are transverse to the pluralities of first and second lines 134, 136 by an angle different from 90-degrees. As shown in Figure ID, the plurality of valleys 138 are spaced laterally apart from the plurality of peaks 140. For example, at least some of the plurality of valleys 138 are between adjacent ones of the plurality of peaks 140, and at least some of the plurality of peaks 140 are between adjacent ones of the plurality of valleys 138.

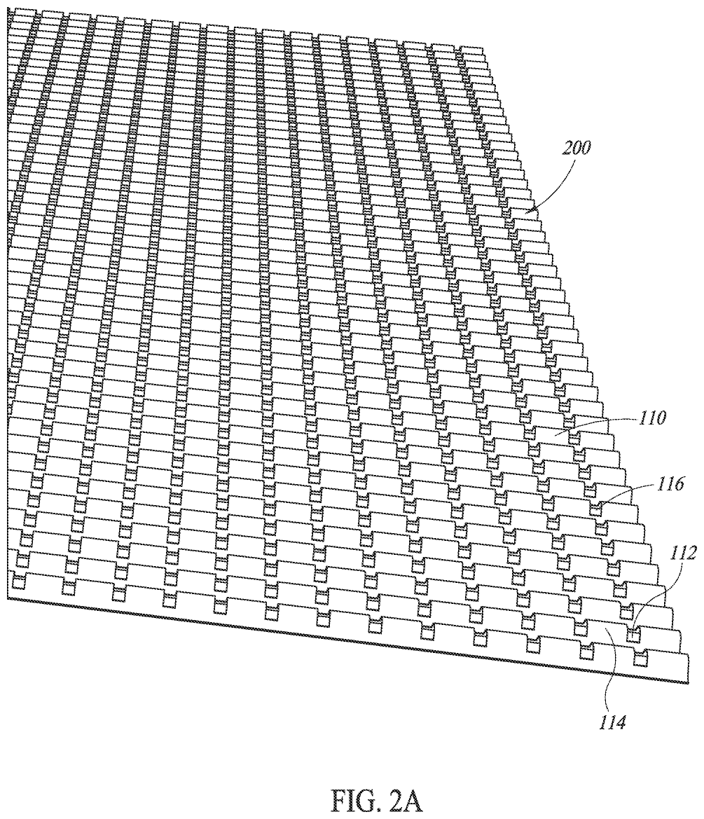

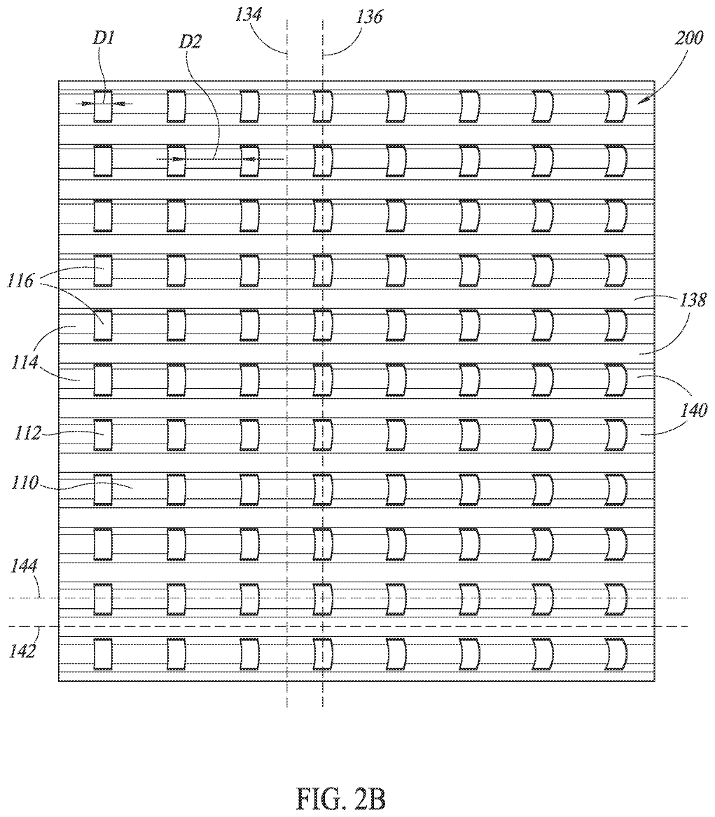

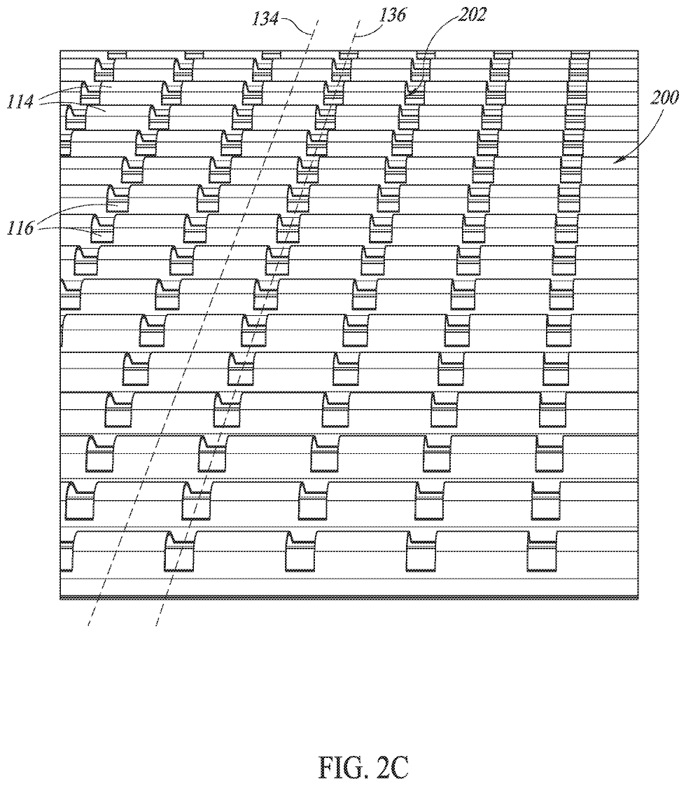

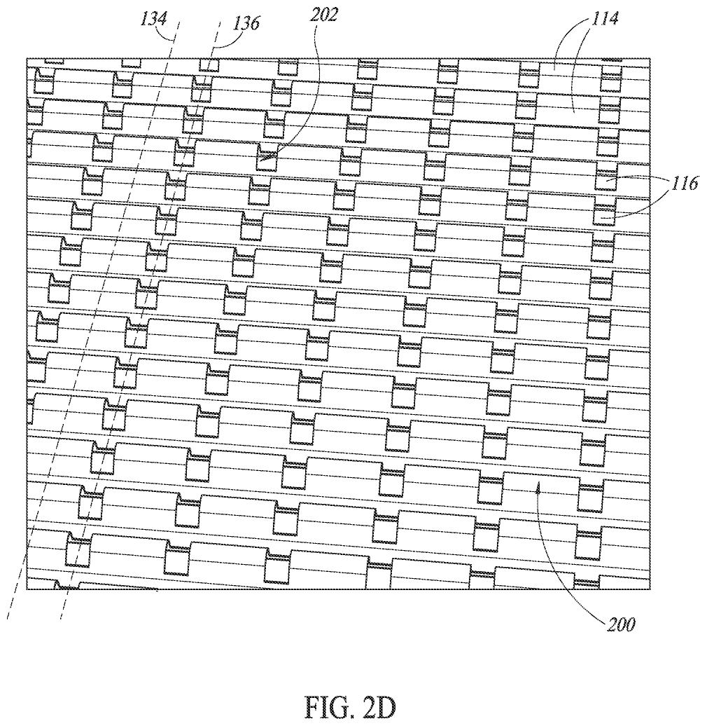

FIG. 2A is a perspective view of an embodiment of a packaging material 200 that includes the inner layer 110 and the outer layer 112 that may be utilized to form the package 100. For example, the packaging material 200 may be formed beforehand such that the packaging material 200 is a stock material that may be utilized to form the package 100. The stock packaging material 200 may be stored on a cylindrical roller or dole such that the stock packaging material 200 may be transported or shipped between various locations. For example, in some embodiments, the packaging material 200 may be singulated into two rectilinear shapes. These two rectilinear shapes may then be stacked on each other at which point the first and second sealed edges 126, 128 are formed. The first and second sealed edges 126, 128 may be formed by applying heat, pressure, or both at locations along the stacked rectilinear portions of the packaging material 200 causing an adhesive on one or both of the inner and outer layers 110, 112 to be activated. This activation of the adhesive results in the formation of the first and second sealed edges 126, 128, respectively, sealing together the two rectilinear portions of the packaging material 200 forming a package.

Alternatively, the package 100 may be formed by forming a single rectilinear portion and folding the single rectilinear portion to form the folded edge 132. After the folded edge 132 is formed, the first and second sealed edges 126, 128, respectively, are formed in a similar process as discussed directly above. Once the folded edge 132 and the first and second sealed edges 126, 128 are formed, the respective portion of the packaging material 200 including the folded edge 132, the first sealed edge 126, and the second sealed edge 128 may undergo further processing to form the completed package 100 (e.g., adding the adhesive on the closure flap 122 and covering the adhesive on the closure flap with the release liner.

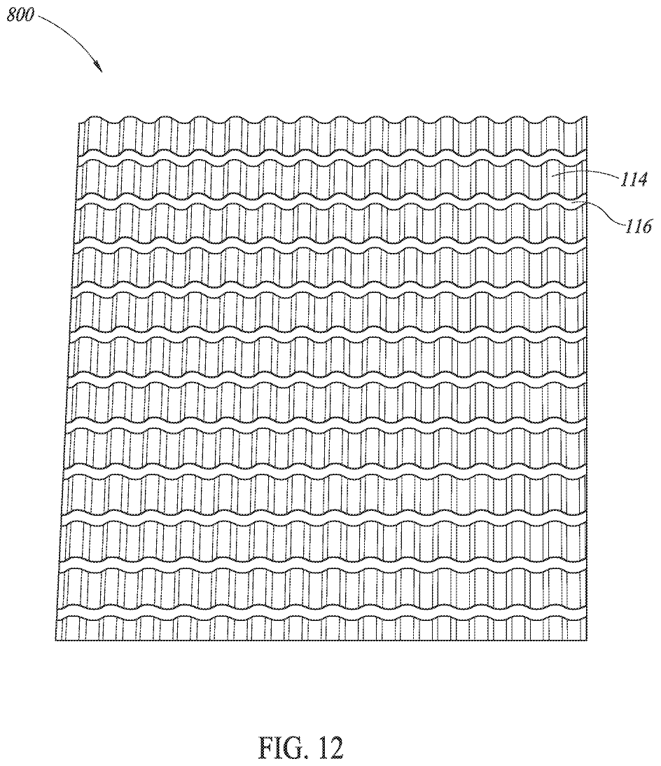

FIGS. 2B, 2C, and 2D are various zoomed in, perspective views of the packaging material 200 as shown in FIG. 2A. As may more readily be seen in FIG. 2B, the packaging material 200 includes the inner layer 110 and the outer layer 112, which is exposed from the inner layer 110 by the plurality of slits 116. As shown in FIG. 2B, the plurality of slits 116 may be separate and distinct from each other, and the plurality of slits 116 terminate before reaching the outer layer 112, respectively. In other words, the outer layer 112 is fully intact as the plurality of slits 116 does not extend through the outer layer 112. In some alternative embodiments, the plurality of slits 116 may be replaced with continuous slits (see FIG. 12 of the present disclosure) due to portions of the valleys 138 between the plurality of slits 116 as shown in FIG. 2B being removed as well.

A first dimension D1 of the plurality of slits 116 extends between adjacent ones of the plurality of sub-flutes 114, and a second dimension D2 of the plurality of sub-flutes 114 extends between adjacent ones of the plurality of slits 116. The first dimension D1 may be a ½-inches, ¼-inches, ⅛-inches, 1/16-inches, or may be some other dimension of the plurality of slits. As shown in FIG. 2B, the first dimension D1 is less than the second dimension D2. However, in some alternative embodiments, the first dimension D1 may be greater than the first dimension D2 such that the plurality of slits 116 may be larger than the plurality of sub-flutes 114.

As shown in FIGS. 2A-2D, a plurality of sub-flute cavities 202 are below each one of the plurality of sub-flutes 114. The plurality of sub-flute cavities 202 are separate and distinct from each other, and the plurality of sub-flute cavities are configured to act similar to bubbles of a bubble mailer. For example, the plurality of sub-flute cavities 202 along with the plurality of sub-flutes 114 allow for the plurality of sub-flutes 114 to give under pressure and provide cushioning to a product that may be being shipped within the package 100 made from the packaging material 200. In other words, the peaks 140 of the plurality of sub-flutes 114 may compress and deform inward such that the plurality of sub-flutes 114 cushion a product within the package 100 while being shipped to a customer to reduce a likelihood of the product being damaged during shipment.

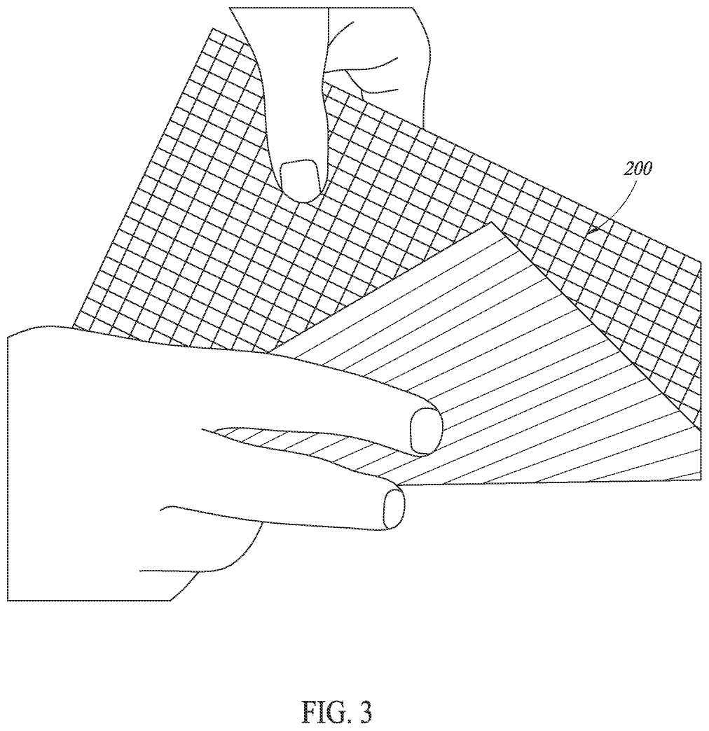

FIG. 3 is a perspective view of the packaging material 200 being bent. FIG. 3 illustrates the ability of the packaging material 200 to be conformable, bendable, and flexible such that the packaging material 200 would readily conform, bend, and flex around various shaped and sized products. At the same time, the plurality of sub-flutes 114 are configured to perform and provide cushion in a similar fashion as a bubble in a conventional bubble mailer, which generally are made of a polyethylene material (e.g., low-density polyethylene (LDP)). However, unlike these bubble mailers, the inner layer 110 and the outer layer 112 of the packaging material 200 are made of a plant-based material, a fiber-based material, a pulp-based material, or some other suitable recyclable and/or biodegradable material. The packaging material 200 is recyclable and/or biodegradable such that the impact on the environment is reduced relative to the conventional bubble mailers made of the polyethylene material. For example, the carbon foot-print of manufacturing and shipping products with the package 100 formed with the packaging material 200, which is recyclable and/or biodegradable, is reduced relative to that of the conventional bubble mailers made of the polyethylene material. Nevertheless, the plurality of sub-flutes 114 provides cushioning or support similar to the bubbles in the conventional bubble mailer such that the products of various sizes and shapes are protected and cushioned during shipment to a consumer to reduce the likelihood of the products being damaged while being shipped to the customer.

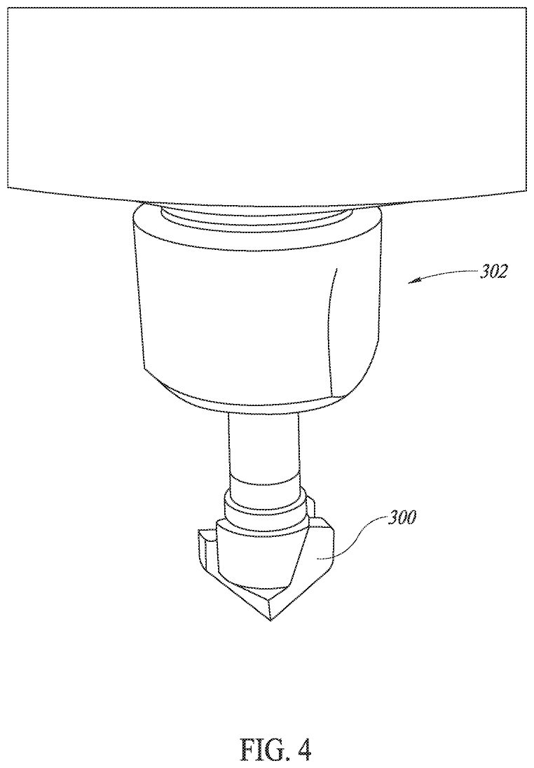

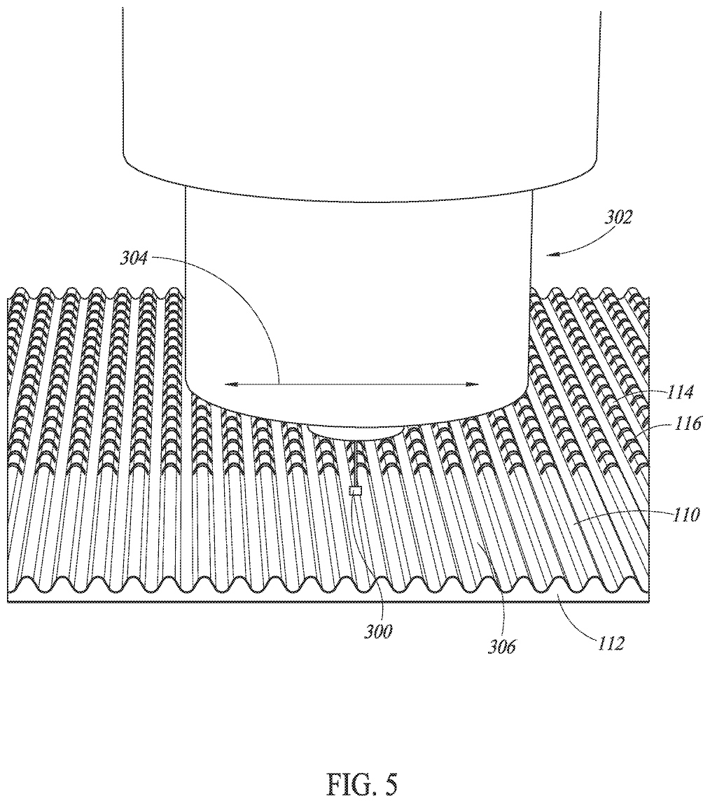

FIG. 4 is a perspective view of an embodiment of a cutting end 300 of a router 302 of the present disclosure. The cutting end 300 of the router 302 may be utilized to cut away material of the fluted inner layer 110 to form the plurality of slits 116 and define the plurality of sub-flutes 114 of the inner layer 110. This method of manufacturing the plurality of slits 116 with the cutting end 300 of the router 302 to define the plurality of sub-flutes 114 will be discussed in further detail with respect to FIG. 5 of the present disclosure.

FIG. 5 is a perspective view of a method of forming the plurality of slits 116 with the cutting end 300 of the router 302. For example, the cutting end 300 of the router 302 rotates quickly about an axis of rotation of the router 302 as the router 302 moves the cutting end 300 back and forth across a plurality of flutes 306 of the packaging material 200 to form the plurality of slits 116 and the plurality of sub-flutes 114, respectively. The plurality of flutes 306 may be A-flutes, B-flutes, C-flutes, E-flutes, F-flutes, or some other suitable type or sized and shaped flutes that may be utilized for the plurality of flutes 306. The movement of the router 302 back and forth across the plurality of flutes 306 of the packaging material 200 is represented by an arrow 304. For example, the router 302 may move the cutting tool 300 across the plurality of flutes 306 at a depth at which the plurality of flutes 306 of the inner layer 110 are cut forming the plurality of slits 116, but does not cut into or through the outer layer 112. The router 302 may first move in a rightward direction to form ones of the plurality of slits 116 along one of the plurality of second lines 136. Once the router 302 reaches the end of the plurality of flutes 306 at the right-hand side of the packaging material 200, the router 302 passes back along the plurality of flutes 306 in a left-ward direction cutting away material of the plurality of flutes 306 to form ones of the plurality of slits 116 along an adjacent one of the plurality of second lines 136. This back and forth movement of the router 302 may be repeated in succession to form the plurality of slits 116 along the plurality of second lines 136, which results in the formation of the plurality of sub-flutes 114 along the plurality of first lines 134. In other words, forming the plurality of slits 116 defines and forms the plurality of sub flutes 114.

In at least the embodiment as shown in FIG. 5, when utilizing the router 302 to form the packaging material 200 with the plurality of sub-flutes 114 and the plurality of slits 116, the packaging material 200 may be laid flat on a flat surface (e.g., a flat tabletop). Laying the packaging material 200 flat on the flat surface allows for the router 302 to move back and forth along the plurality of flutes 306 in quick succession to form the plurality of slits 116 and the plurality of sub-flutes 114.

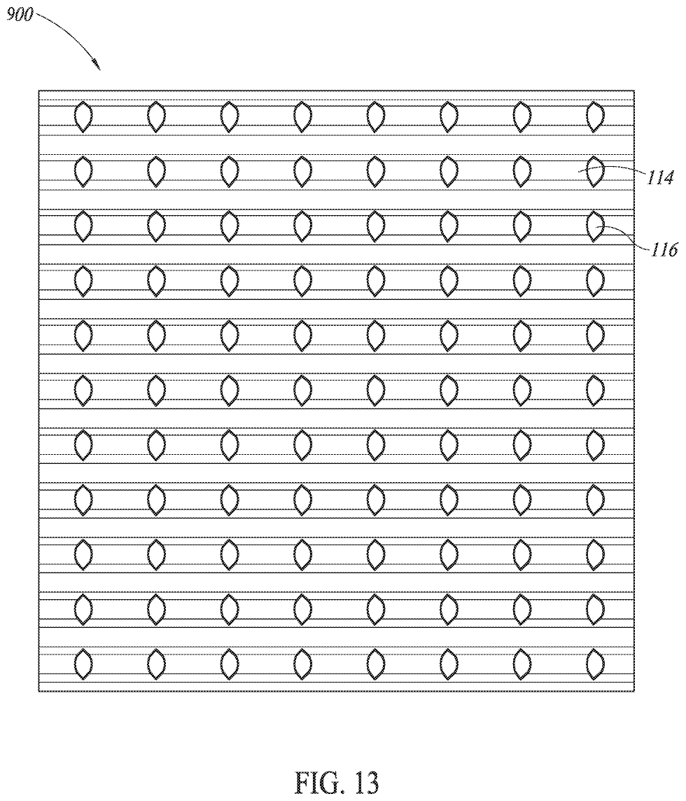

A cutting edge of the cutting end 300 may be shaped and sized to cut various shaped and sized ones of the plurality of slits 116. For example, a first embodiment of the cutting end 300 may be sized and shaped to cut rectangular shaped ones of the plurality of slits 116 as shown in FIGS. 2A-2D, whereas a second embodiment of the cutting end 300 may be sized and shaped to cut diamond-like or diamond shaped ones of the plurality of slits 116 (see FIG. 13 of the present disclosure). In alternative embodiments, the cutting end 300 may be sized and shaped to cut other shaped and sized ones of the plurality of slits 116 (e.g., circular, parallelepiped, etc.).

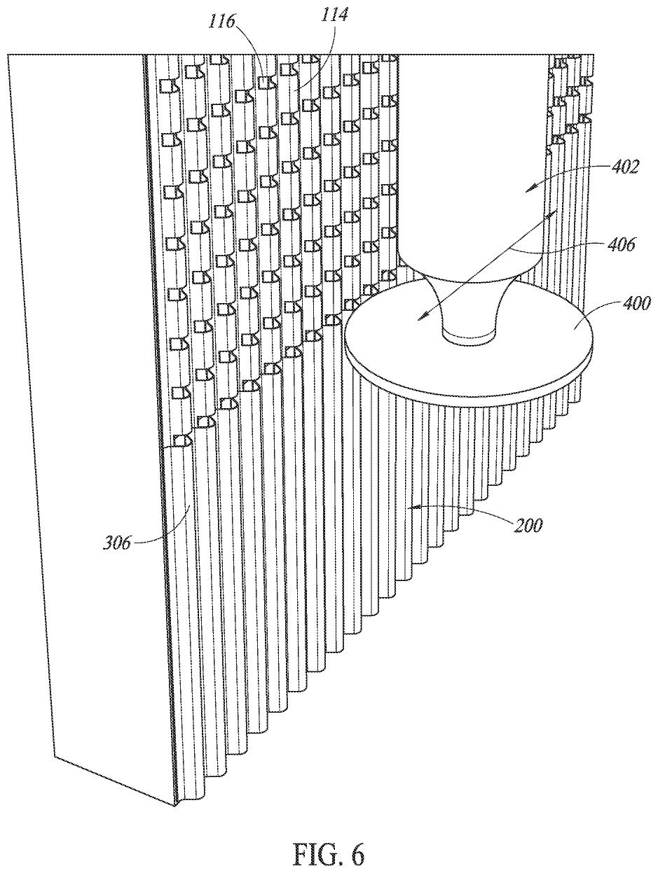

FIG. 6 is a perspective view of a method of forming the plurality of slits 116 with a saw blade 400 of a saw blade router 402. For example, the saw blade 400 rotates quickly about an axis of rotation of the saw blade router 402 as the saw blade router 402 moves the saw blade 400 back and forth across the plurality of flutes 306 of the packaging material 200 to form the plurality of slits 116 and the plurality of sub-flutes 114, respectively. The movement of the saw-blade router 402 back and forth across the plurality of flutes 306 of the packaging material 200 is represented by an arrow 406. For example, the saw blade router 402 may move the saw blade 400 across the plurality of flutes 306 at a depth at which the plurality of flutes 306 of the inner layer 110 are cut forming the plurality of slits 116, but does not cut into or through the outer layer 112. The saw blade router 402 may first move in a leftward direction to form ones of the plurality of slits 116 along one of the plurality of second lines 136. Once the saw blade router 402 reaches the end of the plurality of flutes 306 at the left-hand side of the packaging material 200, the saw blade router 402 passes back along the plurality of flutes 306 in a right-ward direction cutting away material of the plurality of flutes 306 to form ones of the plurality of slits 116 along an adjacent one of the plurality of second lines 136. This back and forth movement of the saw blade router 402 may be repeated in succession to form the plurality of slits 116 along the plurality of second lines 136, which results in the formation of the plurality of sub-flutes 114 along the plurality of first lines 134. In other words, forming the plurality of slits 116 defines and forms the plurality of sub-flutes 114.

In at least the embodiment as shown in FIG. 6, when utilizing the saw blade router 402 to form the packaging material 200 with the plurality of sub-flutes 114 and the plurality of slits 116, the packaging material 200 may be mounted to a flat surface in a vertical orientation such that the saw blade 400 may readily pass through and cut away material of the plurality of flutes 306 of the packaging material 200. The vertical orientation may be transverse to the horizontal orientation as shown in FIG. 5 of the present disclosure.

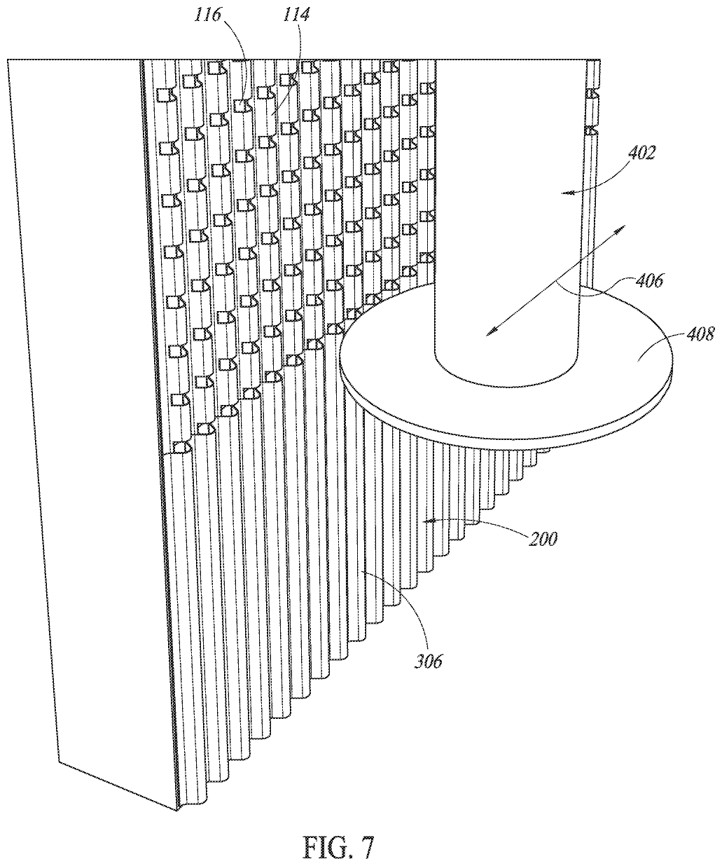

FIG. 7 is a perspective view of a method of forming the plurality of slits 116 with a saw blade 408 of the saw blade router 402. As shown in FIG. 7, the plurality of slits 116 may be formed utilizing the saw blade 408 in the same or similar fashion as with the saw blade 400 as discussed above with respect to FIG. 6.

The saw blade 408 as shown in FIG. 7 is larger than the saw blade 400 as shown in FIG. 6. The saw blade 408 may be larger than the saw blade 400 depending on the types of material that the inner layer 110 may be formed from. Alternatively, the saw blade 408 may have a cutting edge shaped slightly differently from a cutting edge of the saw blade 400 such that the plurality of slits 116 cut by the saw blade 408 are different in size and shape than the plurality of slits 116 cut by the saw blade 400. For example, the cutting edge of the saw blade 408 may be shaped such that the plurality of slits 116 have a diamond shape whereas the cutting edge of the saw blade 400 may be shaped such that the plurality of slits 116 have a rectangular shape (see FIGS. 2A-2D of the present disclosure).

In some alternative embodiments, a laser cutting device may be utilized to form the plurality of slits 116 instead of the saw blade router 402 and the router 302, respectively. For example, similar to how the router 302 and the saw blade router 402 passes back and forth across and along the plurality of flutes 306 to form the plurality of slits 116 and the plurality of sub-flutes 114, the laser cutting device may be moved back and forth and turned on and off in succession while passing across and along the plurality of flutes 306 to form the plurality of slits 116 and the plurality of sub-flutes 114.

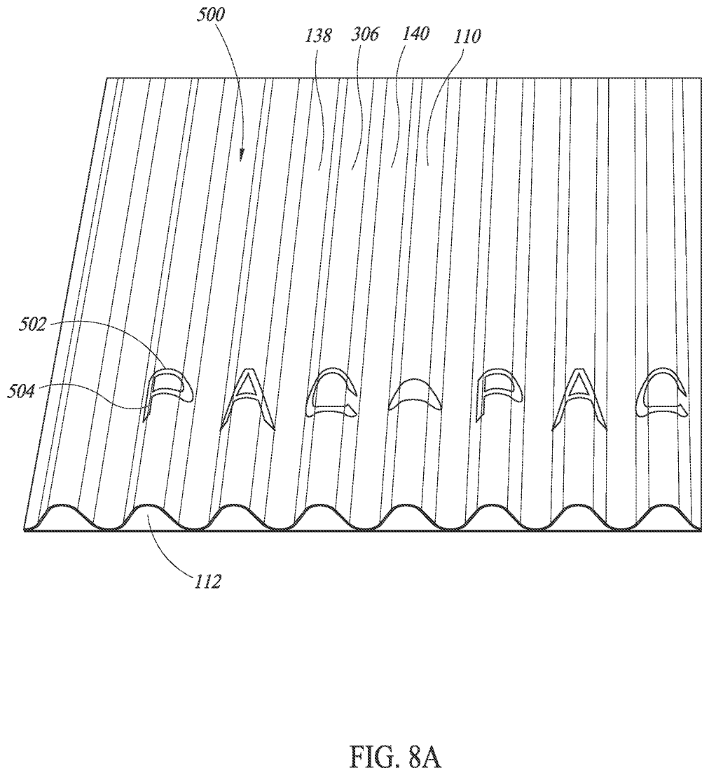

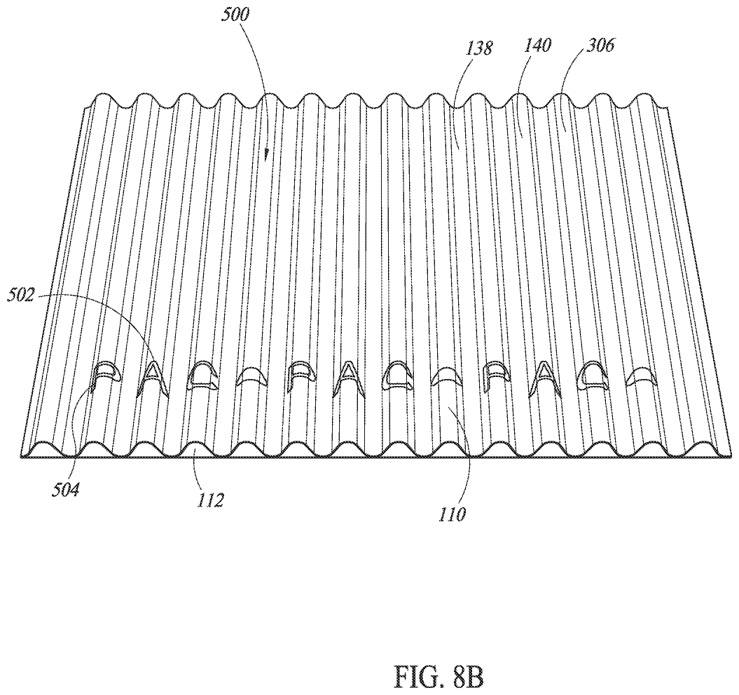

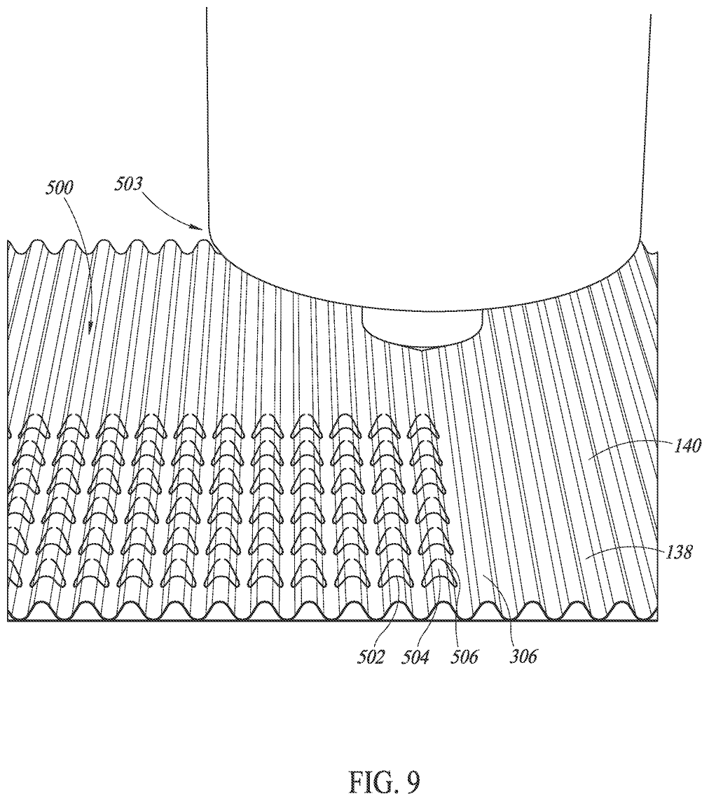

FIGS. 8A and 8B are perspective views of a plurality of patterned slits 502 formed in a packaging material 500. The plurality of patterned slits 502 may be formed utilizing a laser cutting device 503, which will be discussed in further detail with respect to FIG. 9 of the present disclosure later herein. As shown in FIGS. 8A and 8B, the plurality of patterned slits 502 spell out “PAC.” The plurality of patterned slits 502 in the same or similar manner as the plurality of slits 116 allow the packaging material 500 to be more conformable to variously sized and shaped products while also providing cushioning and support to variously sized and shaped products in the same or similar manner as the plurality of sub-flutes 114 of the packaging material 200 and the inner layer 100 of the package 100 as discussed earlier herein.

Material portions 504 of the packaging material 500 delimited by respective ones of the plurality of patterned slits 502 due to the formation of the plurality of the patterned slits 502 through the packaging material 500 may remain coupled to the majority of the packaging material 500. For example, extensions may extend from the material portions 504 delimited by respective ones of the plurality of patterned slits 502 to a majority of the packaging material 500. In other words, these extensions result in the material portions 504 of the packaging material 500 delimited within respective ones of the plurality of patterned slits 502 remaining suspended within and coupled to the majority of the rest of the packaging material 500. The plurality of patterned slits 502 extends through the inner layer 110 (e.g., first layer), but does not extend through the outer layer 112 (e.g., second layer).

FIG. 9 is a perspective view of a method of manufacturing an alternative embodiment of the packaging material 500 similar to the packaging material 500 as shown in FIGS. 8A and 8B. However, unlike the packaging material 500 as shown in FIGS. 8A and 8B that have the plurality of patterned slits 502 that spell out “PAC,” in this alternative embodiment as shown in FIG. 9, the patterned slits 502 are circles. Material portions 504, which are circles in the alternative embodiment as shown in FIG. 9, of the packaging material 500 is delimited by respective ones of the plurality of patterned slits 502 remain coupled to the majority of the packaging material 500 by extensions 506. These extensions 506 are similar to the extensions as discussed earlier with respect to FIG. 8A and 8B earlier within the present disclosure.

When the packaging material 500 as shown in FIGS. 8A, 8B, or 9 is utilized to line the package 100, these extensions 506 may rip such that the material portions 504 delimited by respective ones of the plurality of patterned slits 502 break away from the majority of the packaging material 500. This breaking away of the extensions 506 may result in the material portions 504 that have broken away to provide further cushioning within the package 100 while a product is being shipped within the package 100.

The breaking away of the extensions 506 may also provide further cushioning. For example, when the package 100 is dropped, the product within the package pushes against the material delimited within the plurality of patterned slits 502. In reaction, the extensions 506 may flex and bend providing cushioning to the product by absorbing at least some of an impact when the package 100 containing the product comes into contact with a surface (e.g., a ground surface such as a concrete surface, a dirt surface, or some other type of surface on which the package 100 containing the product may be dropped). This bending or flexure of the extensions may cushion the product and reduce the likelihood of the product breaking when the package 100 is dropped.

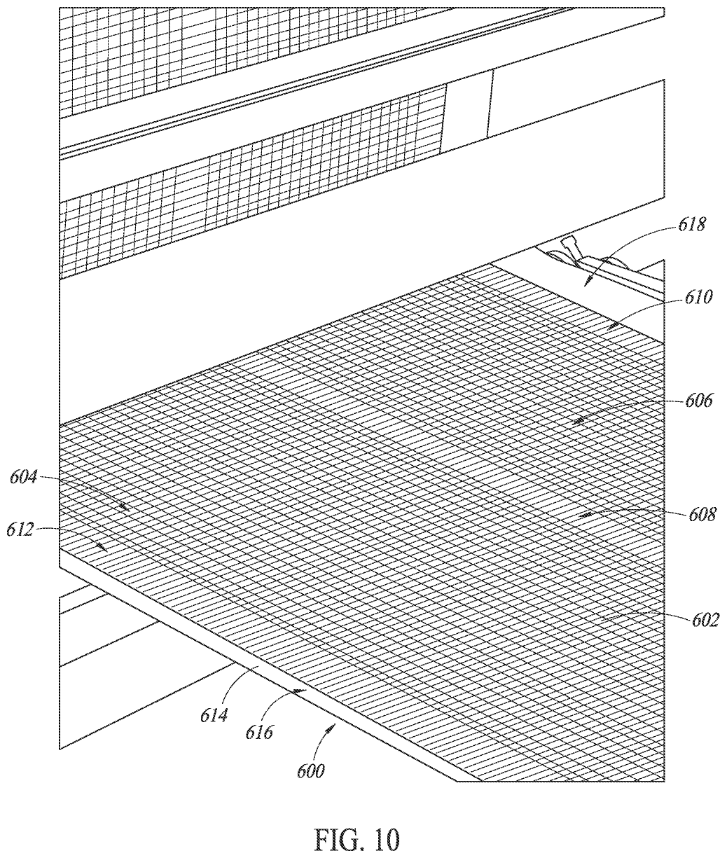

FIG. 10 is a perspective view of an alternative embodiment of the packaging material 600 of the present disclosure. The packaging material 600 is similar to the inner layer 110 and outer layer 112 of the package 100 and the respective packaging materials 200, 500 of the present disclosure.

The packaging material 600 includes a first layer 602 that includes a first region 604, a second region 606, a third region 608, a fourth region 610, and a fifth region 612. The packaging material 200 includes a second layer 614 that is coupled to the first layer 602. For example, the second layer 614 is coupled to the first layer 602 by an adhesive such as a temperature-activated adhesive, a pressure-activated adhesive, or some other suitable type of adhesive that may be utilized to adhere the first layer 602 to the second layer 614. The first layer 602 may be similar to the inner layer 110 of the package 100 of the present disclosure, and the second layer 614 may be similar to the outer layer 112 of the package 100 of the present disclosure.

The first and second regions 604, 606 may have structural features the same or similar to the inner layer 110 of the package 100 and/or the respective packaging materials 200, 500 of the present disclosure. The third region 608 is present between the first and second regions 604, 606 such that the third region separates the first region 604 from the second region 606. The third region 608 may have flutes the same or similar to respective flutes of the plurality of flutes 306. The third region 608 may be along a fold line or a seal line about which the packaging material 600 as shown in FIG. 10 is folded about or sealed about to form a respective edge of a package, for example, the respective edges 126, 128, 132 of the package 100 as shown in FIGS. 1A-1D of the present disclosure.

The fourth and fifth regions 610, 612 are on opposites sides of the first, second, and third regions 604, 606, 608. The fourth region 610 may have flutes the same or similar to the respective flutes of the plurality of flutes 306. The fifth region 612 may have flutes the same or similar to the respective flutes of the plurality of flutes 306. The fourth and fifth regions 610, 612 may be along respective fold lines or seal lines about which the packaging material 600 as shown in FIG. 10 is folded about or sealed about to form a respective edge of a package, for example, the respective edges 126, 128, 132 of the package 100 as show in FIGS. 1A-1D.

The second layer 614 includes a first peripheral region 616 and a second peripheral region 618 that are on opposite sides of the first layer 602. The first peripheral region 616 extends outward from the fifth region 612 of the first layer 602, and the second peripheral region 618 extends outward from the fourth region 610 of the first layer 602.

The packaging material 600 may be singulated along various locations to form various rectilinear or polygonal-shaped portions of the packaging material 600 The various rectilinear or polygonal-shaped portions may then be adhered or sealed together to form various embodiments of packages within the scope of the present disclosure. Alternatively, the various rectilinear or polygonal shaped portions may be singulated to be folded to form one or more folded edges (e.g., the folded edge 132 of the package 100) to form various embodiments of packages within the scope of the present disclosure.

The various widths and positional relationships between these various respective regions 604, 606, 608, 610, 612, 616, 618 of the first and second layers 602, 614 of the packaging material 600 may be adjusted and adapted such that various shaped and sized embodiments of packages may be manufactured utilizing the various embodiments of the packaging materials. For example, in some embodiments, additional regions similar to the first and second regions 604, 606 may be provided and additional regions similar to the third region 608 may be provided between these additional regions similar to the first and second regions 604, 606.

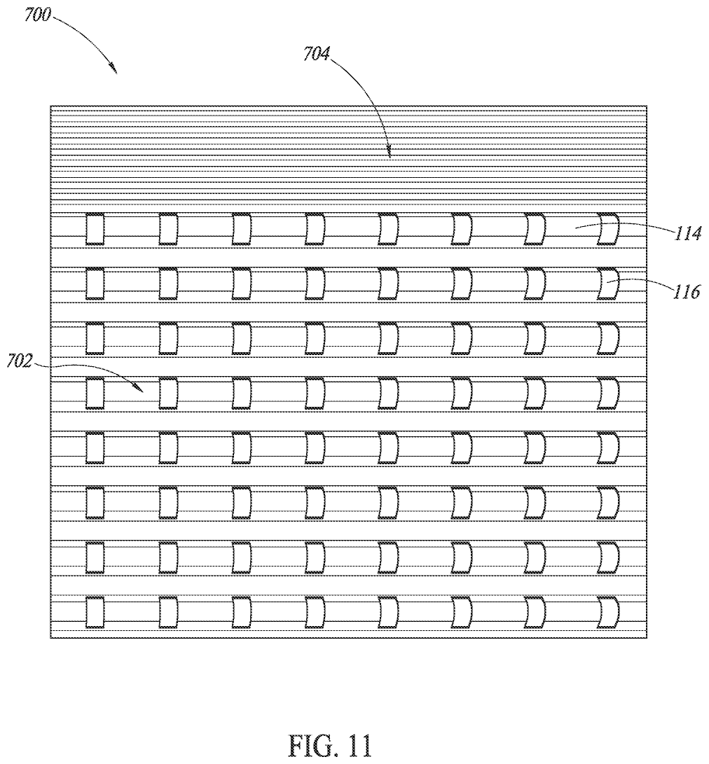

FIG. 11 is a top plan view of a packaging material 700 of the present disclosure. The packaging material 700 includes a first region 702 and a second region 704 adjacent to the first region 702. The second region 704 is at an upper end of the packaging material 700 based on the orientation as shown in FIG. 11. The first region 702 has the same or similar features as the plurality of sub-flutes 114 and the plurality of slits 116 as shown in FIGS. 2A-2D of the present disclosure. The plurality of slits 116 may extend through a plurality of B-flutes to form the plurality of sub-flutes 114. The second region 704 is a fluted region that includes a plurality of F-flutes such that the plurality of sub-flutes, which are B-type sub-flutes, transition to the plurality of F-flutes at the second region 704 at the upper end of the packaging material 700. In some embodiments, the plurality of B-flutes may be replaced with different sized flutes (e.g., A, C, D, E, F, G type flutes). In some embodiments, the plurality of F-flutes may be replaced with different sized flutes (e.g., A, B, C, D, E, G type flutes).

FIG. 12 is a top plan view of a packaging material 800 of the present disclosure. The packaging material 800 includes the plurality of slits 116 and the plurality of sub-flutes 114. However, unlike the packaging material 200 as shown in FIGS. 2A-2D in which the plurality of slits 116 are separate and distinct perforations that extend through the inner layer 110, the plurality of slits 116 as shown in FIG. 12 are instead continuous slits that extend continuously across the plurality of flutes to form the plurality of sub-flutes 114. Unlike the material of the inner layer 110 along the valleys 138 of the plurality of sub-flutes 114 that extends fully across the outer layer 112 as shown in FIGS. 2A-2D, this material has instead been removed to form the plurality of slits 116 such that the plurality of slits 116 are continuous slits instead of perforations as shown in FIGS. 2A-2D.

FIG. 13 is a top plan view of an alternative embodiment of a packaging material 900 of the present disclosure. Unlike the packaging material 200 as shown in FIGS. 2A-2D in which the plurality of slits 116 are rectangular shaped, the plurality of slits 116 as shown in FIG. 13 are diamond-like shaped instead of rectangular shaped.

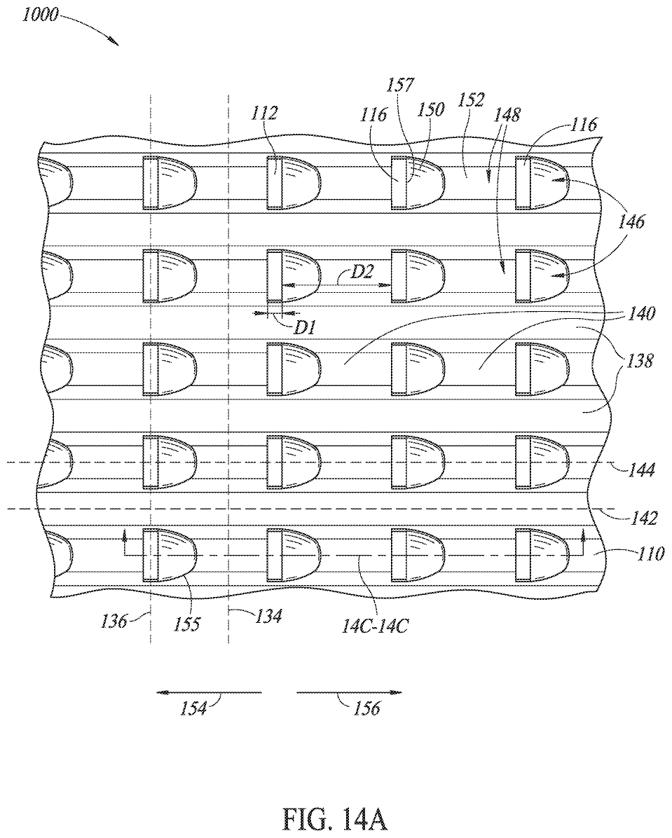

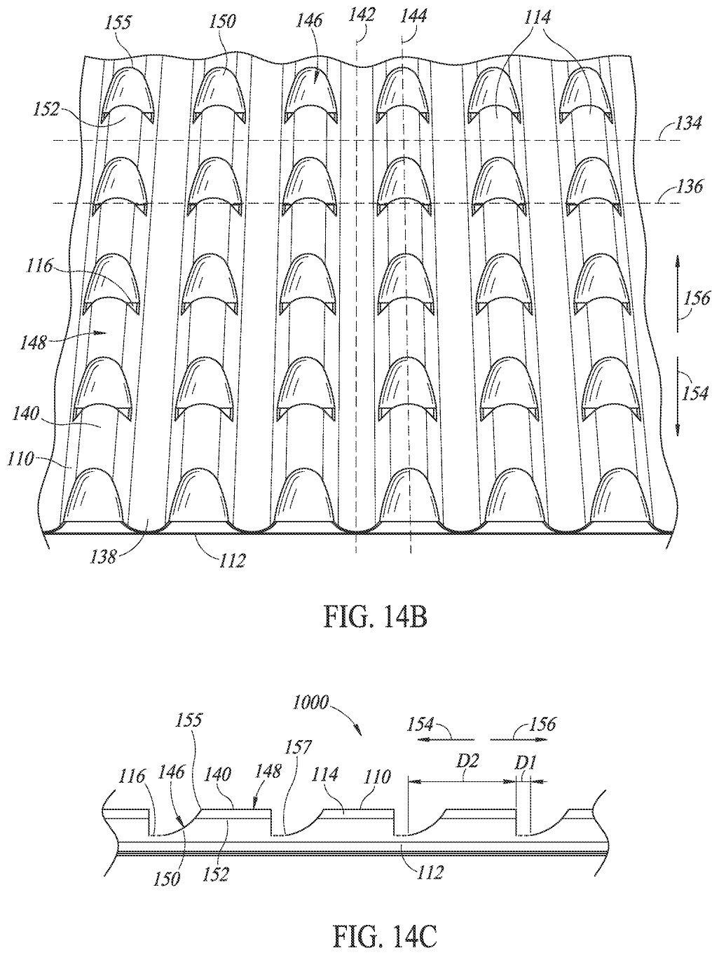

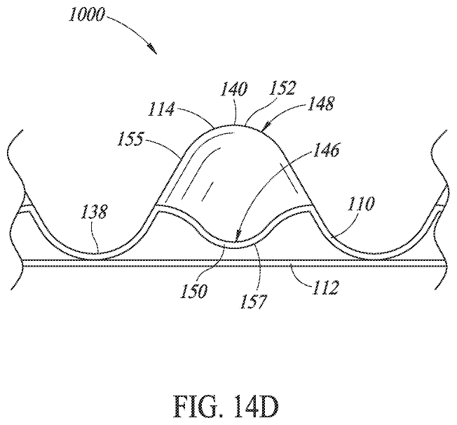

FIG. 14A is a top plan view of an alternative embodiment of a packaging material 1000 of the present disclosure, and FIG. 14B is an angled perspective view of the packaging material 1000 of the present disclosure. The alternative embodiment of the packaging material 1000 has some features that may be like those of the packaging material 200, and, therefore, like reference numerals have been utilized to indicate the like features of the packaging material 1000 as shown in FIGS. 14A-14D relative to the packaging material 200.

However, unlike the packaging material 200, the packaging material 1000 includes a plurality of surfaces 146 and a plurality of curved surfaces 148. Each one of the plurality of surfaces 146 is a corresponding surface of a crushed portion or a compressed portion 150 of a corresponding one of the plurality of sub-flutes 114. In some embodiments, the plurality of surfaces 146 may be flat surfaces, may be concave surfaces, may be convex surfaces, may be partially concave surfaces, may be partially flat surfaces, may be partially concave surfaces, or may be some other combination of these various types of surfaces that may be part of the crushed or compressed portion 150. For example, in some alternative embodiments of the packaging material 1000, each one of the plurality of surfaces 146 may include a peripheral portion that extends around a central portion, and the peripheral portion may be convex while the central portion may be concave (e.g., an indentation, dimple, compression, etc.). In these alternative embodiments, the peripheral portion may be arced and extend from the central portion to a corresponding one of the plurality of curved surfaces 148 at which the peripheral portion of the surface 146 meets the corresponding curved surface 148 at a corresponding one of rounded edges 155. In other words, the peripheral portions of the plurality of surfaces 146 may have a torus-like profile while the central portions of the plurality of surfaces may have a hemispherical-like profile (e.g., indentation, dimple, etc.).

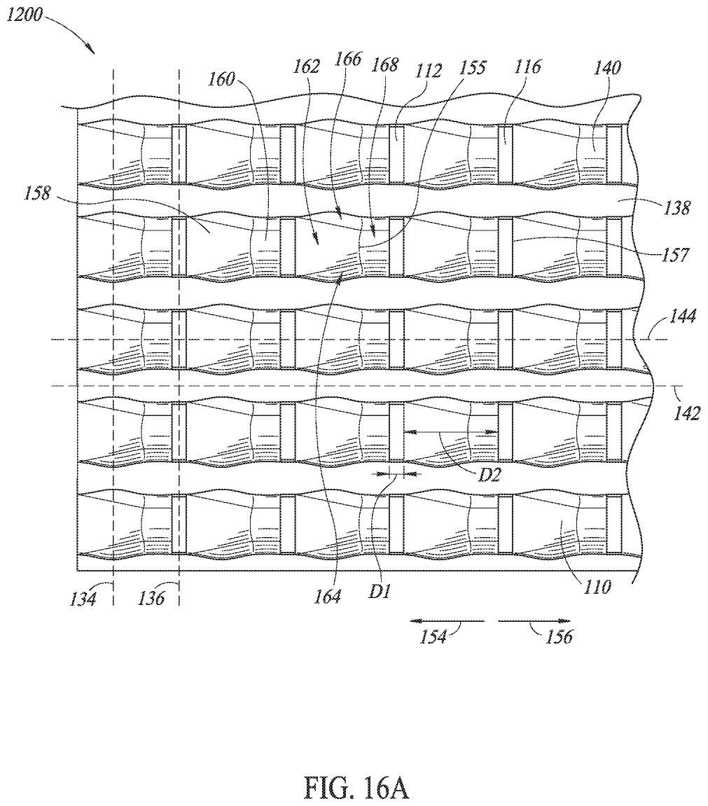

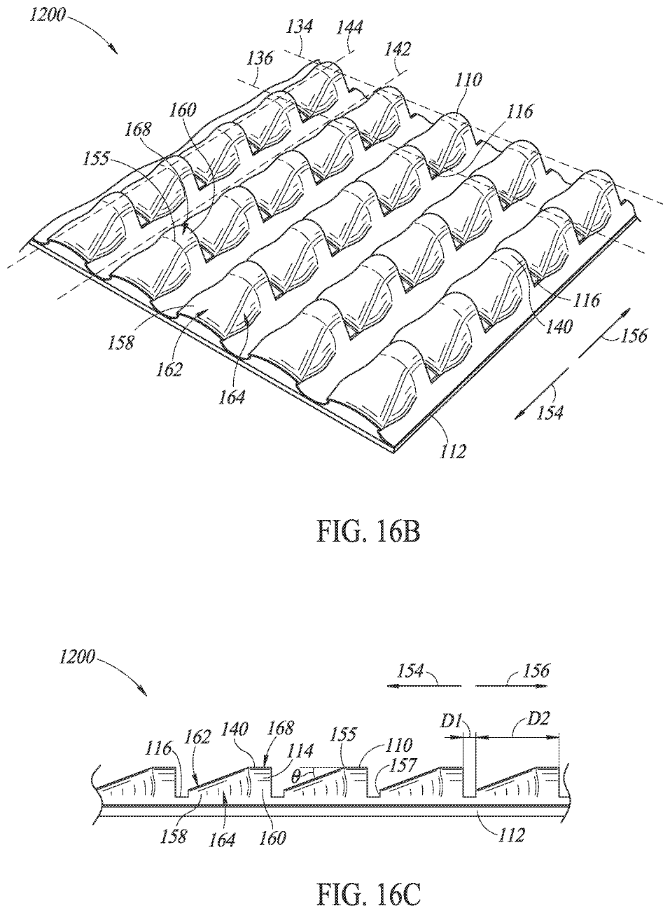

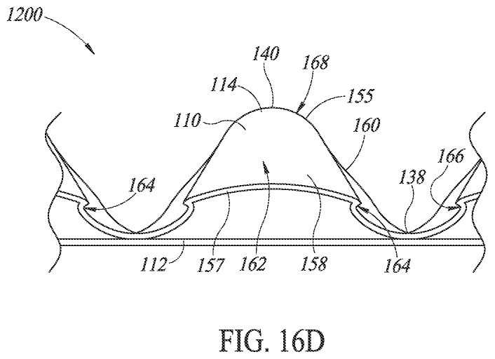

Each one of the plurality of curved surfaces 148 is a corresponding surface of a raised portion or suspended portion 152 (e.g., bubble portion) of a corresponding one of the plurality of sub-flutes 114. Each one of the plurality of raised portions 152 is adjacent to a corresponding one of the plurality of crushed portions 150. The plurality of raised portions 152 may cushion or protect a product when within a package formed including the plurality of sub-flutes 114 as shown in FIGS. 14A-14D. In some embodiments, when the plurality of surfaces 146 are relatively flat, an angle between the plurality of surfaces 146 and the plurality of curved surfaces 148 may be at an angle equal to 45-degrees, at an angle less than 45-degrees, or at some other suitable or selected angle (see angle θ as shown in FIG. 16C by way of example).

As shown in FIG. 14A, each one of the plurality of surfaces 146 is a concave surface and is adjacent to a corresponding one of the plurality of slits 116 such that each one of the plurality of the surfaces 146 is between one of the plurality of slits 116 and one of the plurality of raised portions 152. In the embodiment as shown in FIG. 14A of the packaging material 1000, each one of the plurality of surfaces 146 has a first end at the corresponding one of the plurality of slits 112 and a second end at the corresponding one of the plurality of raised portions 152. The first end of each one of the plurality of surfaces 146 is in closer proximity to the outer layer 112 than the second end of each one of the plurality of surfaces 146. In the embodiment as shown in FIG. 14A of the packaging material 1000, the plurality of curved surfaces 148 are convex surfaces. When viewed in FIG. 14A, the plurality of surfaces 146 have a parabolic-like shape or profile.

The packaging material 1000 may be utilized to form an alternative embodiment of the package 100 such that the plurality of sub-flutes 114 including the plurality of crushed portions 150 and the plurality of raised portions 152 are present within and line the internal cavity 106 of the package 100. For example, a first arrow 154 represents a first direction directed from the folded edge 132 at the second end 130 of the package 100 towards the opening 104 of the package 100, and a second arrow 156 represents a second direction directed from the opening 104 of the package 100 towards folded edge 132 at the second end 130 of the package 100. For example, a product may be inserted through the opening 104 into the internal cavity 106 of the package by moving the product in the second direction 156, and the product may be removed from the internal cavity 106 of the package 100 by moving the product in the first direction 154.

When the plurality of sub-flutes 114 including the plurality of crushed portions 150 and the plurality of raised portions 152 are oriented in the fashion as shown in FIG. 14A within the internal cavity 106 of the package 100, a packager or employee packing a product or item into the package 100 may easily insert the product or item into the internal cavity 106 without the product catching on ones of plurality of sub-flutes 114 due to the presence of the plurality of slits 116. For example, as the product is inserted into the package 100 by the packager in the second direction 156, the product may slide along the plurality of surfaces 146 and the plurality of curved surfaces 148 such that the product does not catch on relatively sharp or abrupt edges 157 of the plurality of sub-flutes 114 due to the presence of the plurality of slits 116. In this embodiment, the sharp or abrupt edges 157 partially delimit the plurality of slits 116. Points at which the plurality of surfaces 146 meet the plurality of curved surfaces 148 have rounded edges 155, and the sharp and abrupt edges 157 are in closer proximity to the outer layer 112 than the rounded edges 155. When the product is inserted into the internal cavity 106 of the package 100 in the second direction 156, the product slides past these rounded edges 155 and does not snag or catch on the sharp or abrupt edges 157 such that the product does not get hung up or rip ones of the plurality of sub-flutes 114. This reduction in the likelihood of ripping of the plurality of sub-flutes 114 increases cushioning or support provided by the plurality of sub-flutes 114 to the product when being shipped within the package to the product's destination.

As shown in FIG. 14A, the rounded edges 155 have the parabolic-like shape as well since the rounded edges 155 are edges of the plurality of surfaces 146. This parabolic-like shape may readily be seen in FIG. 14D as well.

FIG. 14C is a cross-sectional view of the packaging material 1000 taken along line 14C-14C as shown in FIG. 14A. As shown in FIG. 14C, each one of the plurality of sub-flutes 114 has the same structure as the other ones of the plurality of sub-flutes 114. Each one of the plurality of surfaces 146 is transverse to the plurality of curved surfaces 148. While the rounded edges 155 in FIG. 14C come to a point as shown in FIG. 14C, in alterative embodiments, the rounded edges 155 at which respective ones of the crushed portions 150 and respective ones of the raised portions 152 meet may be more curved such that the rounded edges 155 may be convex.

FIG. 14D is a front side view of one of the plurality of sub-flutes 114. As shown in FIG. 14D, the plurality of surfaces 146 are surfaces of dimples, indentations, divots, or some other similar or like structure for which the plurality of surfaces 146 are a respective surface. In other words, the plurality of crushed portions 150 may be referred to as dimples, indentations, divots, or some other similar or like reference to the structure of the plurality of crushed portions 150. As discussed earlier, in alternative embodiments, these dimples, indentations, divots, or similar or like structures may include respective peripheral portions of the plurality of surfaces 146 having torus-like profiles and respective central portions at least partially surrounded by ones of the peripheral portions, and the respective central portions of the plurality of surfaces 146 may have a hemispherical-like profile.

In an alternative embodiment of the packaging material 600 as shown in FIG. 10, the packaging material 600 may have the plurality of sub-flutes 114 as shown in FIGS. 14A-14D. For example, the plurality of sub-flutes 114 as shown in FIGS. 14A-14D may be structures of the first layer 602, and may be present at the first and second regions 604, 606 of the first layer 602. In this alternative embodiment of the packaging material 600 that includes the plurality of sub-flutes 114 as shown in FIGS. 14A-14D, the third, fourth, and fifth regions 608, 610, 612 may have the same or similar structure of the packaging material 600 as shown in FIG. 10. This alternative embodiment of the packaging material 600 may be utilized to form the package 100 by singulating the alternative embodiment of the packaging material 600, folding the alternative embodiment of the packaging material 600, or a combination of both to form the package 100.

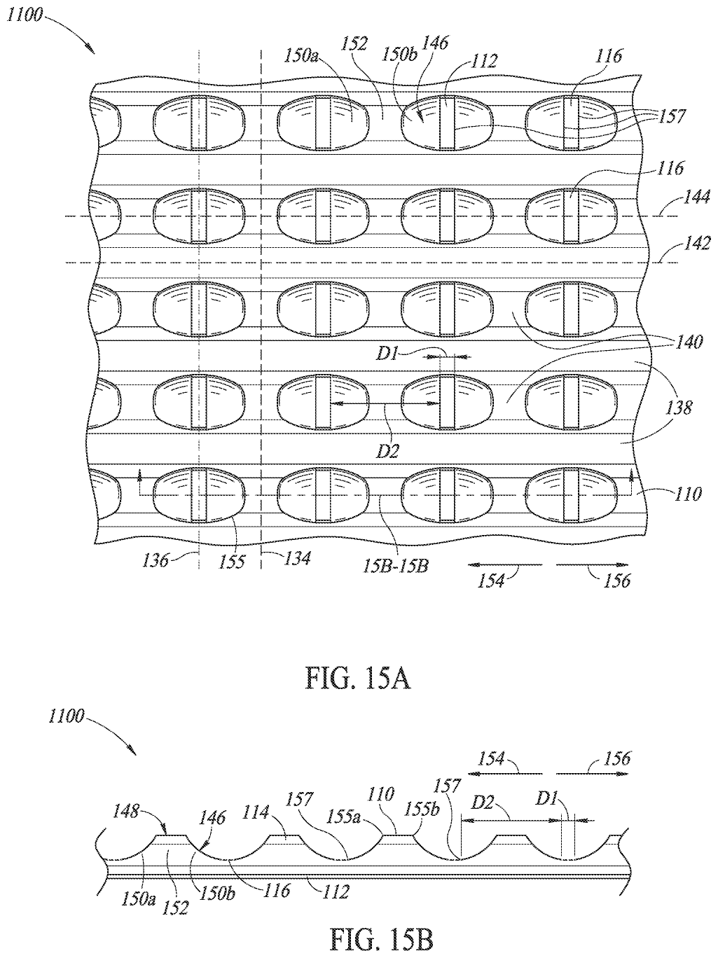

FIG. 15A is a top plan view of an alternative embodiment of a packaging material 1100 similar to the alternative embodiment of the packaging material 1000 as shown in FIGS. 14A-14D. The alternative embodiment of the packaging material 1100 has some features that may be like those of the packaging material 200, and, therefore, like reference numerals have been utilized to indicate the like features of the packaging material 1100 as shown in FIGS. 15A and 15B relative to the packaging material 200.

However, unlike the packaging material 1000 as shown in FIGS. 14A-14D, the packaging material 1100 as shown in FIG. 15A includes additional ones of the plurality of crushed portions 150 such that each one of the plurality of sub-flutes 114 includes a pair of crushed portions 150a, 150b. A first one 150a of the pair of crushed portions 150a, 150b is at a first side of a corresponding one of the plurality of sub-flutes 114 and a second one 150b of the pair of crushed portions 150a, 150b is at a second side of the corresponding one of the plurality of sub-flutes 114 opposite to the first side. For example, the first side may be at the left-hand side of the corresponding one of the plurality of sub-flutes based on the orientation as shown in FIG. 15A, and the second side may be at the right-hand side of the corresponding one of the plurality of sub-flutes based on the orientation as shown in FIG. 15A. In other words, unlike the packaging material 1000 in which there is a one-to-one relationship between the plurality of crushed portions 150 and the plurality of raised portions 152, the packaging material 1100 has a two-to-one relationship between the plurality of crushed portions 150 and the plurality of raised portions 152 such that each one of the plurality of sub-flutes 114 includes the pair of crushed portions 150a, 150b, respectively, of the plurality of crushed portions 150.

When viewed from the front side, the first one 150a of the pair of crushed portions 150a, 150b may have the same or similar structure as the crushed portion 150 as shown in FIG. 14D. When viewed from the rear side, the second one 150b of the pair of crushed portions 150a, 150b may have the same or similar structure as the crushed portion 150 as shown in FIG. 14D.

FIG. 15B is a cross-sectional view of the packaging material 1100 taken along line 15B-15B as shown in FIG. 15A. Again, unlike the packaging material 1000 in which each one of the plurality of sub-flutes 114 includes only one of the plurality of crushed portions 150, each one of the plurality of sub-flutes 114 of the packaging 1100 includes the pair of crushed portions 150a, 150b of the plurality of crushed portions. In other words, each one of the plurality of raised portions 152 is between the first one 150a and the second one 150b of the corresponding pair of crushed portions 150a, 150b of the plurality of crushed portions 150.

Similar to the packaging material 1000 as shown in FIGS. 14A-14D that may be utilized in forming the alternative embodiment of the package 100, the packaging material 1100 as shown in FIGS. 15A and 15B may be utilized to form an alternative embodiment of the package 100 in which the plurality of sub-flutes 114 of the packaging material 1100 line the internal cavity 106 of the package 100. Similar to the packaging material 1000, the first ones 150a of the plurality of crushed portions 150 at the left-hand side of the plurality of sub-flutes 114 as shown in FIG. 15B function in the same or similar fashion as the plurality of crushed portions 150 as shown in FIGS. 14A-14D. For example, a product shipped within the internal cavity 106 of the package 100 may readily be inserted into the package 100 by a packager without having the product snag or catch on the plurality of sub-flutes 114 due to the presence of rounded edges 155a even with the presence of the plurality of slits 116. These rounded edges 155a are between corresponding ones of the plurality of first ones 150a of the plurality of crushed portions 150 and the plurality of raised portions 152. In other words, the product will readily slide or move across the rounded edges 155a without catching or snagging on the plurality of sub-flutes 114 when being inserted into the internal cavity 106 of the package 100 in the second direction 156. While the rounded edges 155a, 155b in FIG. 15B come to a point as shown in FIG. 15B, in alterative embodiments, the rounded edges 155 at which respective ones of the crushed portions 150 and respective ones of the raised portions 152 meet may be more curved such that the rounded edges 155a, 155b may be convex.

The plurality of sub-flutes 114 that include the second ones 150b of the plurality of crushed portions 150 as shown in FIGS. 15A and 15B may also allow for the product to be removed without snagging ones of the plurality of sub-flutes 114 from the package 100. For example, a product being removed from the internal cavity 106 of the package 100 by a consumer may readily be removed by the consumer without having the product snag or catch on the plurality of sub-flutes 114 due to the presence of rounded edges 155b even with the presence of the plurality of slits 116. These rounded edges 155b are between corresponding ones of the plurality of second ones 150b of the plurality of crushed portions 150 and the plurality of raised portions 152. In other words, the product will readily slide or move across the rounded edges 155b without catching or snagging on the plurality of sub-flutes 115 when being removed from the internal cavity 106 of the package 100 in the first direction 154.

In an alternative embodiment of the packaging material 600 as shown in FIG. 10, the packaging material 600 may have the plurality of sub-flutes 114 as shown in FIGS. 15A and 15B. For example, the plurality of sub-flutes 114 as shown in FIGS. 15A and 15B may be structures of the first layer 602, and may be present at the first and second regions 604, 606 of the first layer 602. In this alternative embodiment of the packaging material 600 that includes the plurality of sub-flutes 114 as shown in FIGS. 15A and 15B, the third, fourth, and fifth regions 608, 610, 612 may have the same or similar structure of the packaging material 600 as shown in FIG. 10. This alternative embodiment of the packaging material 600 may be utilized to form the package 100 by singulating the alternative embodiment of the packaging material 600, folding the alternative embodiment of the packaging material 600, or a combination of both to form the package 100.

FIG. 16A is a top plan view of an alternative embodiment of a packaging material 1200 of the present disclosure, and FIG. 16B is a perspective view of the packaging material 1200 of the present disclosure. The alternative embodiment has some features that may be like the packaging material 200, and, therefore, like reference numerals have been utilized to indicate the like features of the packaging material 1200 as shown in FIGS. 16A-16D relative to the packaging material 200.

However, unlike the packaging material 200, the plurality of sub-flutes 114 of the packaging material 1200 as shown in FIGS. 16A-16D have a different structure than the plurality of sub-flutes 114 of the packaging material 200 as shown in FIGS. 2A-2D. As shown in FIG. 16A, each one of the plurality of sub-flutes 114 of the packaging material 1200 includes a crushed portion 158 and a raised portion 160 that is adjacent to the crushed portion 158. The crushed portion 158 includes a surface 162 that extends from a first surface or sidewall 164 and a second surface or sidewall 166 opposite to the first surface or sidewall 166. In the embodiment as shown in FIGS. 16A-16D, the surface 162 is flat, however, in some alternative embodiments, the surface 162 may be curved such as having a concave surface, a convex surface, a partially concave surface, a partially convex surface, a partially flat surface, or some other combination of these various types of surfaces. The raised portion 160 includes a curved surface 168 that extends between opposite ones of a pair of the plurality of valleys 138 on opposite sides of ones of the plurality of sub-flutes 114. The curved surface 168 is adjacent to the first and second sidewalls 164, 166 and the surface 162. The flat surface is transverse and angled relative to an inner surface of the outer layer 112 to which the inner layer 110 is coupled. The rounded edge 155 is between the curved surface 168 and the first and second sidewalls 164, 166, and the rounded edge 155 is between the curved surface 168 and the surface 162. As shown in FIGS. 16A-16D, the curved surface 168 is a convex surface.

The first and second sidewalls 164, 166 may be pinched surfaces or sidewalls that have creases that extend along their length from a corresponding one of the plurality of slits 116 to a corresponding one of the plurality of raised portions 160. In other words, the first and second concave sidewalls 164, 166 are rounded inwards towards center axes of corresponding ones of the plurality of sub-flutes 114. For example, the center axes of the plurality of sub-flutes 114 are along the plurality of fourth lines 144 as shown in FIG. 16A. In other words, the first and second sidewalls 164, 166 may be concave surfaces.

FIG. 16C is a side view of the packaging material 1200 as shown in FIGS. 16A and 16B. The first sidewalls 164 are readily visible and are concaved or rounded inwards into the page towards the center axes of the plurality of sub-flutes 114 based on the orientation as shown in FIG. 16C. While the rounded edges 155 in FIG. 14C come to a point as shown in FIG. 14C, in alterative embodiments, the rounded edges 155 at which respective ones of the crushed portions 158 and respective ones of the raised portions 160 meet may be more curved such that the rounded edges 155 may be convex.

FIG. 16D is a front side view of one of the plurality of sub-flutes 114 of the packaging material 1200. As shown in FIG. 16D, the surface 162 has a parabolic-like shape, and the rounded edge 155 has the parabolic-like shape as well. As shown in FIG. 16D, the first and second sidewalls 164, 166 are rounded or concaved inwards towards the center axes of the plurality of sub-flutes 114.

Similar to the packaging materials 1000, 1100 as shown in FIGS. 14A-14D, 15A, and 15B, respectively, that may be utilized in forming the alternative embodiment of the package 100, the packaging material 1200 as shown in FIGS. 16A-16D may be utilized to form an alternative embodiment of the package 100 in which the plurality of sub-flutes 114 of the packaging material 1200 line the internal cavity 106 of the package 100. Similar to the packaging materials 1000, 1100, each one of the plurality of crushed portions 158 is at the left-hand side of one of the plurality of sub-flutes 114 as shown in FIGS. 16A-16C function in the same or similar fashion as the plurality of crushed portions 150 as shown in FIGS. 14A-14D and the plurality of crushed portions 150a as shown in FIGS. 15A and 15B. For example, a product shipped within the internal cavity 106 of the package 100 may readily be inserted into the internal cavity 106 by a packager or employee without having the product snag or catch on the plurality of sub-flutes 114 due to the presence of rounded edges 155 even with the presence of the plurality of slits 116. These rounded edges 155 are between corresponding ones of the plurality of crushed portions 158 and the plurality of raised portions 160, these rounded edges 155 are between corresponding ones of the surfaces 168 and corresponding ones of the first and second sidewalls 164, 166, and these rounded edges 155 are between corresponding ones of the surfaces 168 and corresponding ones of the surfaces 158. In other words, the product will readily slide or move across the rounded edges 155 without catching or snagging on the plurality of sub-flutes 114 when being inserted into the internal cavity 106 of the package 100 in the second direction 156 reducing the likelihood of ripping ones of the plurality of sub-flutes 114, respectively.

In an alternative embodiment of the packaging material 600 as shown in FIG. 10, the packaging material 600 may have the plurality of sub-flutes 114 as shown in FIGS. 16A-16D. For example, the plurality of sub-flutes 114 as shown in FIG. 16A-16D may be structures of the first layer 602, and may be present at the first and second regions 604, 606 of the first layer 602. In this alternative embodiment of the packaging material 600 that includes the plurality of sub-flutes 114 as shown in FIGS. 16A-16D, the third, fourth, and fifth regions 608, 610, 612 may have the same or similar structure of the packaging material 600 as shown in FIG. 10. This alternative embodiment of the packaging material 600 may be utilized to form the package 100 by singulating the alternative embodiment of the packaging material 600, folding the alternative embodiment of the packaging material 600, or a combination of both to form the package 100.

The respective crushed portions 150, 150a, 150b, 158 may be formed simultaneously along with the plurality of slits 116 by a cutting tool that is structured with a cutting portion and a crushing portion that cuts the plurality of slits 116 while simultaneously forming the respective crushed portions 150, 150a, 150b, 158 by partially crushing the plurality of sub-flutes 114. In an alternative embodiment, the respective crushed portions 150, 150a, 150b, 158 may be formed after the plurality of slits 116 are formed. For example, the plurality of slits 116 may be formed by a cutting tool (e.g., saw, blade, laser, etc.), and, after the plurality of slits 116 are formed, the respective crushed portions 150, 150a, 150b, 158 may be formed by a crushing tool that crushes the plurality of sub-flutes 114 forming the respective crushed portions 150, 150a, 150b, 158 depending on which one of the packaging materials 1000, 1100, 1200 is being formed.

In view of the above discussion with respect to the packaging materials 1000, 1100, 1200 as shown in FIGS. 14A-14D, 15A, 15B, and 16A-16D, respectively, the respective crushed portions 150, 150a, 150b, 158 of the packaging materials 1000, 1100, 1200, respectively, may allow a product to be slide into and out of a mailer or package for shipping the product depending on the position and orientation of the respective crushed portions 150, 150a, 150b, 158. The respective raised portions 152, 160 of the packaging materials 1000, 1100, 1200, respectively, may provide cushioning and protection to the product when being shipped within a mailer or package to a consumer. In other words, the combination of the respective crushed portions 150, 150a, 150b, 158 may improve usability of the mailer or package to avoid ripping or tearing the plurality of sub-flutes 114 when the product is being packed into the mailer or package, when the product is being removed from the mailer or package, or both depending on the position and the orientation of the respective crushed portions 150, 150a, 150b, 158. This reduction in the likelihood of tearing or ripping in the plurality of sub-flutes due to the presence of the respective crushed portions 150, 150a, 150b, 158 even when the plurality of slits 116 are present may increase cushioning provided by the respective raised portions 152, 160 while the product is present within the mailer or package as the respective raised portions 152, 160 are not ripped or torn by inserting or removing the product from the mailer or package.

In view of the above discussion with respect to the packaging materials 1000, 1100, 1200 as shown in FIGS. 14A-14D, 15A, 15B, and 16A-16D, respectively, the respective crushed portions 150, 150a, 150b, 158 of the packaging materials 100, 1100, 1200 may provide additional clearance between adjacent ones of the plurality of sub-flutes 114. For example, when the packaging materials 1000, 1100, 1200 are bent or deformed in a similar fashion as shown in FIG. 3, the crushed portions 150, 150a, 150b, 158 allow for the adjacent ones of the plurality of sub-flutes 114 to articulate further without coming into contact with each other. In other words, the degree of freedom between adjacent ones of the plurality of sub-flutes 114 is increased when the crushed portions 150, 150a, 150b, 158 and the plurality of slits 116 are present. This increased degree of freedom due to the presence of the crushed portions 150, 150a, 150b, 158 allows for packages formed from the packaging materials 1000, 1100, 1200 to have greater conformability such that variously sized and shaped products or items may be shipped in the packages. For example, packages formed utilizing the packaging materials 1000, 1100, 1200 may more readily conform to variously sized and shaped products, and this increased conformability may result in greater contact between the raised portions 152, 160 and the products or items within the packages. This increase in contact between the raised portions 152, 160 and the products and items within the packages may result in an increase in cushioning of the products or items when being shipped within the packages reducing the likelihood of damage to the products or items. This increase in conformability may reduce the overall size and footprint of the package when filled with the products or items being shipped. The reduced footprint may reduce shipping costs as the reduced footprint decreases the amount of space that the package filled with the products or items takes up when being shipped.

The embodiments of the packaging materials 200, 500, 600, 700, 800, 900, 1000, 1100, 1200 as shown in FIGS. 2A-2D, 8A, 8B, 9, 10, 11, 12, 13, 14A-14D, 15A, 15B, and 16A-16D may be positioned and stored on a cylindrical rollers or doles as a stock material. The respective packaging materials 200, 500, 600, 700, 800, 900, 1000, 1100, 1200 on the cylindrical rollers or doles may be installed within an envelope or package manufacturing machine or may be shipped to a customer for use in manufacturing packages or envelopes for shipping products to customers. For example, the respective packaging materials 200, 500, 600, 700, 800, 900, 1000, 1100, 1200 may be wrapped or rolled onto the cylindrical rollers or doles. In other words, the respective packaging materials 200, 500, 600, 700, 800, 900, 1000, 1100, 1200 may be rolled onto the cylindrical rollers or doles for transporting or transferring the respective packaging materials 200 as stock material between various locations.

A package of the present disclosure may be summarized as including: a first end; a second end opposite to the first end; a first side that extends from the first end to the second end; a second side opposite to the first side that extends from the first end to the second end; an outer layer made of a first recyclable material, the outer layer including an internal surface and an external surface opposite to the internal surface; an inner layer made of a second recyclable material, the inner layer coupled to the outer layer, the inner layer including: a plurality of sub-flutes including peaks spaced apart from the outer layer and valleys coupled to the internal surface of the outer layer, wherein each one of the peaks is between adjacent ones of the valleys and each one of the valleys is between adjacent ones of the peaks; and a plurality of slits that extends along and past the plurality of sub-flutes and define each respective sub-flute of the plurality of sub-flutes; a first sealed edge at the first side; a second sealed edge at the second side; a folded edge at the second end; and an opening at the first end.

The plurality of sub-flutes may include a first set of sub-flutes and a second set of sub-flutes offset relative to each other, respective peaks of the second set of sub-flutes may be nested within respective valleys of the first set of sub-flutes, and respective peaks of the first set of sub-flutes may be nested within respective valleys of the second set of sub-flutes.

The package may further include a closure flap at the first end of the package.

The package may further include an adhesive on the closure flap.

The package may further include a release liner on and covering the adhesive on the closure flap.

The first recyclable material may be the same as the second recyclable material.

The first recyclable material may be different from the second recyclable material.

A method of the present disclosure may be summarized as including: coupling a fluted layer made of a first recyclable material to an outer layer made of a second recyclable material; forming a plurality of cut away slits through a plurality of flutes of the fluted layer defining a plurality of sub-flutes in the fluted layer; folding along a fold location of the fluted layer and the outer layer to form a folded edge of a package; and forming an opening of the package by forming opposing sealed edges opposite to each other and extending from folded edge to the opening.

Forming the opposing sealed edges may include compressing ones of the plurality of flutes of the fluted layer.

Forming the opposing sealed edges may include applying heat to the outer layer and the fluted layer to activate an adhesive layer present at opposing sealing locations at which the opposing sealed edges are formed.

A packaging material of the present disclosure may be summarized as including: an outer layer made of a first recyclable material, the outer layer including an internal surface and an external surface opposite to the internal surface; and an inner layer made of a second recyclable material, the inner layer coupled to the outer layer, the inner layer including: a plurality of sub-flutes including peaks spaced apart from the outer layer and valleys coupled to the internal surface of the outer layer, each one of the peaks is between adjacent ones of the valleys and each one of the valleys is between adjacent ones of the peaks; and a plurality of slits extends past and along the plurality of sub-flutes and define each respective sub-flute of the plurality of sub-flutes.

Each respective sub-flute of the plurality of sub-flutes may have a first width; and each respective slit of the plurality of slits may have a second width less than the first width.

A packaging material of the present disclosure may be summarized as including: a fluted layer made of a first recyclable material; a base layer made of a second recyclable material; and a patterned slit extending through the fluted layer.

The patterned slit may be in the shape of “PAC” or a circle.

The patterned slit may be configured to provide bendability and flexibility to the fluted layer.

A package of the present disclosure may be summarized as including: a first end; a second end opposite to the first end; a first side that extends from the first end to the second end; a second side opposite to the first side that extends from the first end to the second end; an outer layer made of a first recyclable material, the outer layer including an internal surface and an external surface opposite to the internal surface; an inner layer made of a second recyclable material, the inner layer coupled to the outer layer, the inner layer including: a plurality of flutes including peaks spaced apart from the outer layer and valleys coupled to the internal surface of the outer layer, wherein respective ones of the peaks are between adjacent ones of the valleys and respective ones of the valleys are between adjacent ones of the peaks; and a plurality of patterned slits extends through the plurality of flutes; a first sealed edge at the first side; a second sealed edge at the second side; a folded edge at the second end; and an opening at the first end.

The plurality of patterned slits may be in the shape of “PAC” or a circle.

The plurality of patterned slits may be configured to provide bendability and flexibility to the inner layer.

The package further includes a plurality of slits that mat separate the plurality of flutes into a plurality of sub-flutes defined by the plurality of slits.

A packaging material of the present disclosure may be summarized as including: a first layer made of a first recyclable material, the first layer including a first surface and a second surface opposite to the first surface; and a second layer made of a second recyclable material, the second layer coupled to the first layer, the second layer including: a pair of sub-fluted regions including: a plurality of sub-flutes including peaks spaced apart from the first layer and valleys coupled to the internal surface of the first layer, wherein each one of the peaks is between adjacent ones of the valleys and each one of the valleys is between adjacent ones of the peaks; and a plurality of slits that extends past and along the plurality of sub-flutes and define each respective sub-flute of the plurality of sub-flutes; and a fluted region between a first one and a second one of the pair of sub-fluted regions, the fluted region including a plurality of flutes that extends from the first one to the second one of the pair of sub-fluted regions.

The first one and the second one of the pair of sub-fluted regions may be separated from each other by the fluted region.

A package of the present disclosure may be summarized as including: a first end; a second end opposite to the first end; a first side that extends from the first end to the second end; a second side opposite to the first side that extends from the first end to the second end; an outer layer made of a first biodegradable material, the outer layer including an internal surface and an external surface opposite to the internal surface; and an inner layer made of a second biodegradable material, the inner layer coupled to the outer layer, the inner layer including: a plurality of sub-flutes including peaks spaced apart from the outer layer and valleys coupled to the internal surface of the outer layer, wherein each one of the peaks is between adjacent ones of the valleys and each one of the valleys is between adjacent ones of the peaks; and a plurality of slits that extends along and past the plurality of sub-flutes and define each respective sub-flute of the plurality of sub-flutes; a first sealed edge at the first side; a second sealed edge at the second side; a folded edge at the second end; and an opening at the first end.

The first biodegradable material may be the same as the second biodegradable material.

The first biodegradable material may be different from the second biodegradable material.

A packaging material of the present disclosure may be summarized as including: an outer layer made of a first recyclable material, the outer layer including an internal surface and an external surface opposite to the internal surface; and an inner layer made of a second recyclable material, the inner layer coupled to the outer layer, the inner layer including: a plurality of sub-flutes including peaks spaced apart from the outer layer and valleys coupled to the internal surface of the outer layer, each one of the peaks is between adjacent ones of the valleys, each one of the valleys is between adjacent ones of the peaks, and each one of the plurality of sub-flutes includes at least one crushed portion; and a plurality of slits extends past and along the plurality of sub-flutes and define each respective sub-flute of the plurality of sub-flutes, each one of the plurality of slits adjacent to at least one of the crushed portions of the plurality of sub-flutes.

Each one of the plurality of sub-flutes may include a pair of crushed portions including a first crushed portion and a second crushed portion opposite to the first crushed portion, the at least one crushed portion is the first crushed portion.

A packaging material of the present disclosure may be summarized as including: an outer layer made of a first recyclable material; and an inner layer made of a second recyclable material, the inner layer coupled to the outer layer, the inner layer including: a plurality of slits that extends through the inner layer; and a plurality of sub-flutes between corresponding ones of the plurality of slits, each one of the plurality of sub-flutes including: a first end adjacent to a first one of the plurality of slits; a second end opposite to the first end, the second end is adjacent to a second one of the plurality of slits; a first side extends from the first end to the second end; a second side opposite to the first side, the second side extends from the first end to the second end; and a first crushed portion at the first end.

The first crushed portion may be an indentation with a concave surface facing away from the outer layer and between the first side and the second side.

The first crushed portion may include: a flat surface that faces away from the outer layer; a first concave surface extending from the flat surface towards the outer layer, the first concave surface is at the first side; and a second concave surface opposite to the first concave surface, the second concave surface extending from the flat surface towards the outer layer, the second concave surface is at the second side.

The flat surface may be transverse to an inner surface of the outer layer to which the inner layer is coupled.

Each one of the plurality of sub-flutes may further include: a second crushed portion at the second end of the flute.

The first crushed portion may be a first indentation with a first concave surface facing away from the outer layer and between the first side and the second side; and the second crushed portion may be a second indentation with a second concave surface facing way from the outer layer and between the first side and the second side.

The first crushed portion may include: a first flat surface that faces away from the outer layer; a first concave surface extending from the first flat surface towards the outer layer, the first concave surface is at the first side; and a second concave surface opposite to the first concave surface, the second concave surface extending from the first flat surface towards the outer layer, the second concave surface is at the second side; and the second crushed portion may include: a second flat surface that faces away from the outer layer; a third concave surface extending from the second flat surface towards the outer layer, the third concave surface is at the first side; and a fourth concave surface opposite to the third concave surface, the fourth concave surface extending from the second flat surface towards the outer layer, the fourth concave surface is at the second side.

The first flat surface may be transverse to an inner surface of the outer layer to which the inner layer is coupled; and the second flat surface may be transverse to the inner surface of the outer layer.

U.S. Provisional Patent Application No. 63/340,385, filed on May 10, 2022, and U.S. Provisional Patent Application No. 63/357,583, filed on Jun. 30, 2022, are incorporated herein by reference, in their entirety.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A package, comprising:
a first end;
a second end opposite to the first end;
a first side that extends from the first end to the second end;
a second side opposite to the first side that extends from the first end to the second end;
an outer layer made of a first biodegradable material, the outer layer including an internal surface and an external surface opposite to the internal surface;
an inner layer made of a second biodegradable material, the inner layer coupled to the outer layer, the inner layer including:
a plurality of sub-flutes including peaks spaced apart from the outer layer and valleys coupled to the internal surface of the outer layer, wherein each one of the peaks is between adjacent ones of the valleys and each one of the valleys is between adjacent ones of the peaks; and
a plurality of slits that extends along and past the plurality of sub-flutes and define each respective sub-flute of the plurality of sub-flutes;
a first sealed edge at the first side;
a second sealed edge at the second side;
a folded edge at the second end; and
an opening at the first end.

2. The package of claim 1, wherein the first biodegradable material is the same as the second biodegradable material.

3. The package of claim 1, wherein the first biodegradable material is different from the second biodegradable material.

4. A packaging material, comprising:
an outer layer made of a first recyclable material, the outer layer including an internal surface and an external surface opposite to the internal surface; and
an inner layer made of a second recyclable material, the inner layer coupled to the outer layer, the inner layer including:
a plurality of sub-flutes including peaks spaced apart from the outer layer and valleys coupled to the internal surface of the outer layer, each one of the peaks is between adjacent ones of the valleys, each one of the valleys is between adjacent ones of the peaks, and each one of the plurality of sub-flutes includes at least one crushed portion; and
a plurality of slits extends past and along the plurality of sub-flutes and define each respective sub-flute of the plurality of sub-flutes, each one of the plurality of slits to adjacent to at least one of the crushed portions of the plurality of sub-flutes.

5. The packaging material of claim 4, wherein each one of the plurality of sub-flutes includes a pair of crushed portions including a first crushed portion and a second crushed portion opposite to the first crushed portion, the at least one crushed portion is the first crushed portion.

6. A packaging material, comprising:
an outer layer made of a first recyclable material; and
an inner layer made of a second recyclable material, the inner layer coupled to the outer layer, the inner layer including:
a plurality of slits that extends through the inner layer; and
a plurality of sub-flutes between corresponding ones of the plurality of slits, each one of the plurality of sub-flutes including:
a first end adjacent to a first one of the plurality of slits;
a second end opposite to the first end, the second end is adjacent to a second one of the plurality of slits;
a first side extends from the first end to the second end;
a second side opposite to the first side, the second side extends from the first end to the second end; and
a first crushed portion at the first end.

7. The packaging material of claim 6, wherein the first crushed portion is an indentation with a concave surface facing away from the outer layer and between the first side and the second side.

8. The packaging material of the claim 6, wherein the first crushed portion includes:
a flat surface that faces away from the outer layer;
a first concave surface extending from the flat surface towards the outer layer, the first concave surface is at the first side; and
a second concave surface opposite to the first concave surface, the second concave surface extending from the flat surface towards the outer layer, the second concave surface is at the second side.

9. The packaging material of claim 8, wherein the flat surface is transverse to an inner surface of the outer layer to which the inner layer is coupled.

10. The packaging material of claim 6, wherein each one of the plurality of sub-flutes further includes:
a second crushed portion at the second end of the flute.

11. The packaging material of claim 10, wherein:
the first crushed portion is a first indentation with a first concave surface facing away from the outer layer and between the first side and the second side; and
the second crushed portion is a second indentation with a second concave surface facing way from the outer layer and between the first side and the second side.

12. The packaging material of claim 10, wherein:
the first crushed portion includes:
a first flat surface that faces away from the outer layer;
a first concave surface extending from the first flat surface towards the outer layer, the first concave surface is at the first side; and
a second concave surface opposite to the first concave surface, the second concave surface extending from the first flat surface towards the outer layer, the second concave surface is at the second side; and
the second crushed portion includes:
a second flat surface that faces away from the outer layer;
a third concave surface extending from the second flat surface towards the outer layer, the third concave surface is at the first side; and
a fourth concave surface opposite to the third concave surface, the fourth concave surface extending from the second flat surface towards the outer layer, the fourth concave surface is at the second side.

13. The packaging material of claim 12, wherein:
the first flat surface is transverse to an inner surface of the outer layer to which the inner layer is coupled; and
the second flat surface is transverse to the inner surface of the outer layer.

14. A packaging material, comprising:
a first layer made of a first recyclable material, the first layer including a first surface and a second surface opposite to the first surface; and
a second layer made of a second recyclable material, the second layer coupled to the first layer, the second layer including:
a pair of sub-fluted regions including:
a plurality of sub-flutes including peaks spaced apart from the first layer and valleys coupled to the second surface of the first layer, wherein each one of the peaks is between adjacent ones of the valleys and each one of the valleys is between adjacent ones of the peaks; and
a plurality of slits that extend past and along the plurality of sub-flutes and define each respective sub-flute of the plurality of sub-flutes;
a fluted region between a first one and a second one of the pair of sub-fluted regions, the fluted region including a plurality of flutes that extend from the first one to the second one of the pair of sub-fluted regions.

15. The packaging material of claim 14, wherein the first one and the second one of the pair of sub-fluted regions are separated from each other by the fluted region.

16. A package, comprising:
a first end;
a second end opposite to the first end;
a first side that extends from the first end to the second end;
a second side opposite to the first side that extends from the first end to the second end;
an outer layer made of a first recyclable material, the outer layer including an internal surface and an external surface opposite to the internal surface;
an inner layer made of a second recyclable material, the inner layer coupled to the outer layer, the inner layer including:
a plurality of sub-flutes including peaks spaced apart from the outer layer and valleys coupled to the internal surface of the outer layer, wherein each one of the peaks is between adjacent ones of the valleys and each one of the valleys is between adjacent ones of the peaks; and
a plurality of slits that extends along and past the plurality of sub-flutes and define each respective sub-flute of the plurality of sub-flutes;
a first sealed edge at the first side;
a second sealed edge at the second side;
a folded edge at the second end; and
an opening at the first end.

17. The package of claim 16, wherein the plurality of sub-flutes includes a first set of sub-flutes and a second set of sub-flutes offset relative to each other, respective peaks of the second set of sub-flutes nest within respective valleys of the first set of sub-flutes, and respective peaks of the first set of sub-flutes nest within respective valleys of the second set of sub-flutes.

18. The package of claim 16, further comprising a closure flap at the first end of the package.

19. The package of claim 18, further comprising an adhesive on the closure flap.

20. The package of claim 19, further comprising a release liner on and covering the adhesive on the closure flap.

21. The package of claim 16, wherein the first recyclable material is the same as the second recyclable material.

22. The package of claim 16, wherein the first recyclable material is different from the second recyclable material.

23. A method, comprising:
coupling a fluted layer made of a first recyclable material to an outer layer made of a second recyclable material;
forming a plurality of cut away slits through a plurality of flutes of the fluted layer defining a plurality of sub-flutes in the fluted layer;
folding along a fold location of the fluted layer and the outer layer to form a folded edge of a package; and
forming an opening of the package by forming opposing sealed edges opposite to each other and extending from folded edge to the opening.

24. The method of claim 23, wherein forming the opposing sealed edges includes compressing ones of the plurality of flutes of the fluted layer.

25. The method of claim 23, wherein forming the opposing sealed edges includes applying heat to the outer layer and the fluted layer to activate an adhesive layer present at opposing sealing locations at which the opposing sealed edges are formed.

26. A packaging material, comprising:
an outer layer made of a first recyclable material, the outer layer including an internal surface and an external surface opposite to the internal surface; and
an inner layer made of a second recyclable material, the inner layer coupled to the outer layer, the inner layer including:
a plurality of sub-flutes including peaks spaced apart from the outer layer and valleys coupled to the internal surface of the outer layer, each one of the peaks is between adjacent ones of the valleys and each one of the valleys is between adjacent ones of the peaks; and
a plurality of slits extends past and along the plurality of sub-flutes and define each respective sub-flute of the plurality of sub-flutes.

27. The packaging material of claim 26, wherein:
each respective sub-flute of the plurality of sub-flutes has a first width; and
each respective slit of the plurality of slits has a second width less than the first width.

28. A packaging material, comprising:
a fluted layer made of a first recyclable material;
a base layer made of a second recyclable material; and
a patterned slit extending through the fluted layer.

29. The packaging material of claim 28, wherein the patterned slit is in the shape of “PAC” or a circle.

30. The packaging material of claim 28, wherein the patterned slit is configured to provide bendability and flexibility to the fluted layer.

31. A package, comprising:
a first end;
a second end opposite to the first end;
a first side that extends from the first end to the second end;
a second side opposite to the first side that extends from the first end to the second end;
an outer layer made of a first recyclable material, the outer layer including an internal surface and an external surface opposite to the internal surface;
an inner layer made of a second recyclable material, the inner layer coupled to the outer layer, the inner layer including:
a plurality of flutes including peaks spaced apart from the outer layer and valleys coupled to the internal surface of the outer layer, wherein respective ones of the peaks are between adjacent ones of the valleys and respective ones of the valleys are between adjacent ones of the peaks; and
a plurality of patterned slits extends through the plurality of flutes;
a first sealed edge at the first side;
a second sealed edge at the second side;
a folded edge at the second end; and
an opening at the first end.

32. The package of claim 31, wherein the plurality of patterned slits are in the shape of “PAC” or a circle.

33. The package of claim 31, wherein the plurality of patterned slits are configured to provide bendability and flexibility to the inner layer.

34. The package of claim 31, further comprising a plurality of slits that separate the plurality of flutes into a plurality of sub-flutes defined by the plurality of slits.
